(19) United States
(12) Patent Application Publication
(10) Pub. No.: US 2026/0291628 A1
(43) Pub. Date: Sep. 24, 2026

(54) METHOD AND APPARATUS FOR MANAGING A DATA IN A WIRELESS COMMUNICATION SYSTEM

(71) Applicant: Samsung Electronics Co., Ltd., Suwon-si, Gyeonggi-do (KR)

(72) Inventors: Zhongfeng ZHANG, Beijing (CN); Di SU, Beijing (CN); Chen QIAN, Beijing (CN); Peng LIN, Beijing (CN); Nan QU, Beijing (CN)

(21) Appl. No.: 19/474,466

(22) PCT Filed: Feb. 27, 2024
(86) PCT No.: PCT/KR2024/002529

§ 371 Date: Oct. 10, 2025

(30) Foreign Application Priority Data
May 9, 2023 (CN) 202310520382.X

(51) Int. Cl. H04B 17/318; H04L 5/00

(52) U.S. Cl. CPC H04B 17/318; H04L 5/0005; H04L 5/0044

(57) ABSTRACT

The present disclosure relates to a 5G communication system or a 6G communication system for supporting higher data rates beyond a 4G communication system such as long term evolution (LTE). The embodiments of the present disclosure provide a method performed by a node and a device thereof, which belong to the field of communication technology. A method performed by a user equipment includes receiving information for indicating a set of antenna array element weights, wherein the set of antenna array element weights includes weights for adjusting antenna array elements; receiving a signal based on the information.

### TECHNICAL FIELD

The present disclosure relates to a communication technology field and, specifically, to a method performed by a base station, a method performed by a user equipment, a method performed by a node in a wireless communication system, a base station, a user equipment and a computer readable storage medium.

### BACKGROUND ART

Considering the development of wireless communication from generation to generation, the technologies have been developed mainly for services targeting humans, such as voice calls, multimedia services, and data services. Following the commercialization of 5G (5th generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyperconnectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

The purpose of the present disclosure is to be able to solve at least one of the technical defects in the existing communication methods to better meet the communication needs. In order to achieve this purpose, the technical solutions proposed in the present disclosure are as follows.

### Solution to Problem

According to a first aspect of the embodiments of the present disclosure, there is proposed a method performed by a user equipment, the method includes: receiving information for indicating a set of antenna array element weights, wherein the set of antenna array element weights includes weights for adjusting antenna array elements; receiving a signal based on the information.

Alternatively, the receiving of the signal based on the information includes: determining, based on the information, the set of antenna array element weights from at least one set of antenna array element weights; receiving the signal by using antenna array elements configured based on the weights of the set of antenna array element weights.

Alternatively, the method further includes: receiving configuration information associated with the at least one set of antenna array element weights.

Alternatively, the method further includes: transmitting antenna configuration information of the user equipment and/or information about the number of signals required to perform sensing and/or estimation for received signal; receiving resource configuration information used to obtain the signals.

Alternatively, the signal is at least one of: an echo signal of an uplink signal, a downlink signal, a new signal, wherein the new signal at least includes: a signal in which a reference signal is mapped to a configured frequency domain resource according to an interval.

Alternatively, the interval between adjacent mapped reference signals is determined based on the information about the number of the signals.

Alternatively, the number of the reference signals is determined based on information about the number of array elements in the antenna configuration information.

According to a second aspect of the embodiments of the present disclosure, there is proposed a method performed by a base station, the method includes: determining a set of antenna array element weights from at least one set of antenna array element weights, wherein the set of antenna array element weights includes weights for adjusting antenna array elements; transmitting information for indicating the set of antenna array element weights.

Alternatively, the method further includes: transmitting configuration information associated with the at least one set of antenna array element weights.

Alternatively, the method further includes: receiving antenna configuration information of the user equipment and/or information about the number of signals required to perform sensing and/or estimation for received signal; transmitting resource configuration information used to obtain the signals.

Alternatively, the signal is at least one of: an echo signal of an uplink signal, a downlink signal, a new signal, wherein the new signal at least includes: a signal in which a reference signal is mapped to a configured frequency domain resource according to an interval.

Alternatively, the interval between adjacent mapped reference signals is determined based on the information about the number of the signals.

Alternatively, the number of the reference signals is determined based on information about the number of array elements in the antenna configuration information.

According to a third aspect of the embodiments of the present disclosure, there is proposed a method performed by a node in a wireless communication system, the method includes: obtaining a set of signals; constructing an array signal based on the set of signals; performing sensing and/or estimation for received signal based on the array signal, wherein each signal in the set of signals is obtained by at least one subarray configured with weights, respectively.

Alternatively, the method further includes: obtaining a set of antenna array element weights; for each signal: selecting, from the set of antenna array element weights, a weight vector for the at least one sub-array; adjusting, based on the weight vector, the weights corresponding to each array element in the at least one sub-array.

Alternatively, the adjustment to the weights includes adjusting at least one of a phase and an amplitude of the array element.

Alternatively, the determining of the set of antenna array element weights includes: obtaining information for indicating the set of antenna array element weights; determining, based on the information, the set of antenna array element weights from at least one set of antenna array element weights.

Alternatively, the set of antenna array element weights includes a plurality of weight vectors, wherein the selecting, from the set of antenna array element weights, the weight vector for the at least one sub-array includes: calculating a correlation coefficient between every two weight vectors included in the set of antenna array element weights; selecting the weight vector based on the correlation coefficient.

Alternatively, the selecting of the weight vector based on the correlation coefficient includes: selecting, from the set of antenna array element weights, a weight vector having the lowest correlation coefficient with a weight vector used to receive a previous signal as the weight vector used to receive the current signal.

Alternatively, the signal in the set of signals is at least one of: an echo signal of a downlink signal, an uplink signal, a new signal; wherein the downlink signal at least includes one of: a demodulation reference signal, a channel state information reference signal, a synchronization signal, a physical downlink shared channel, a physical downlink control channel, and the uplink signal at least includes one of: a demodulation reference signal, a sounding reference signal, a physical uplink shared channel, a physical uplink control channel, the new signal at least includes: a signal in which a reference signal is mapped to a configured frequency domain resource at an interval.

Alternatively, the signal in the set of signals is at least one of: an echo signal of an uplink signal, a downlink signal, a new signal; wherein the downlink signal at least includes one of: a demodulation reference signal, a channel state information reference signal, a synchronization signal, a physical downlink shared channel, a physical downlink control channel, the uplink signal at least includes one of: a demodulation reference signal, a sounding reference signal, a physical uplink shared channel, a physical uplink control channel, the new signal at least includes: a signal in which a reference signal is mapped to a configured frequency domain resource at an interval.

Alternatively, the interval between adjacent mapped reference signals is determined based on the number of signals in the set of signals and/or the number of the reference signals is determined based on the number of array elements in the at least one subarray.

Alternatively, the constructing of the array signal based on the set of signals includes: constructing an array signal in a time domain based on at least one sample point of each signal in the set of signals.

Alternatively, the constructing of the array signal based on the set of signals includes: obtaining, based on the set of signals, a set of signals in a frequency domain; constructing an array signal in the frequency domain, based on at least one sample point of each signal in the set of signals in the frequency domain.

Alternatively, the constructing of the array signal based on the set of signals includes: obtaining, based on the set of signals, a set of signals in a frequency domain; performing channel estimation on the set of signals in the frequency domain, to obtain a channel estimated set of signals; constructing a channel estimated array signal based on at least one sample point of each signal in the channel estimated set of signals.

Alternatively, the constructing of the array signal based on the set of signals includes: obtaining, based on the set of signals, a set of signals in a frequency domain; performing channel estimation on the set of signals in the frequency domain, to obtain a channel estimated set of signals; obtaining, based on the channel estimated set of signals, a time delay estimated set of signals; constructing a time delay estimated array signal based on at least one sample point of each signal in the time delay estimated set of signals.

Alternatively, the performing of the sensing and/or estimation for received signal based on the array signal includes: calculating a sample covariance matrix of the array signal; performing, based on the sample covariance matrix, the sensing and/or estimation for received signal.

According to a fourth aspect of the embodiments of the present disclosure, there is provided a base station, including a transceiver; and a processor, coupled to the transceiver and configured to perform the above method performed by a base station of the present disclosure.

According to a fifth aspect of the embodiments of the present disclosure, there is provided a user equipment, which may include a transceiver; and a processor coupled to the transceiver and configured to perform the above method performed by a user equipment of the present disclosure.

According to a sixth aspect of the embodiments of the present disclosure, there is provided an electronic device, including: at least one processor; and at least one memory storing computer-executable instructions, wherein the computer-executable instructions, when run by the at least one processor, cause the at least one processor to perform any one of the methods according to the present disclosure.

According to a seventh aspect of the embodiments of the present disclosure, there is provided a computer-readable storage medium storing instructions, wherein the instructions, when run by at least one processor, cause the at least one processor to perform the methods according to the present disclosure.

The technical solutions provided by the embodiments of the present disclosure brings at least the following beneficial effects:

By receiving signals using the sub-array configured with different weights, it is possible to obtain the required number of signals for sensing and/or estimation for received signal, such that more accurate sensing and/or estimation for received signal may be performed with less resource consumption, while reducing the requirement for the number of RF links.

### Advantageous Effects of Invention

The beneficial effects brought by the technical solutions provided by the embodiments of the present disclosure will be described later in connection with specific optional embodiments, or may be known from the description of the embodiments, or may be learned from the implementation of the embodiments.

### BRIEF DESCRIPTION OF DRAWINGS

In order to more clearly and easily illustrate and understand the technical solutions in the embodiments of the present disclosure, the following is a brief description of the accompanying drawings that need to be used in the description of the embodiments of the present disclosure.

FIG. 1 illustrates an example wireless network according to various embodiments of the present disclosure;

FIG. 2a illustrates an example wireless transmission path according to various embodiments of the present disclosure;

FIG. 2b illustrates an example wireless reception path according to various embodiments of the present disclosure;

FIG. 3a illustrates an example user equipment according to various embodiments of the present disclosure;

FIG. 3b illustrates an example base station according to various embodiments of the present disclosure;

FIG. 4 illustrates a flow diagram of a method performed by a sensing and communication node according to an embodiment of the present disclosure;

FIG. 5a illustrates a flow diagram of a method performed by a sensing and communication node according to another embodiment of the present disclosure;

FIG. 5b illustrates a flowchart of a sensing and communication node constructing an array signal based on time domain signals;

FIG. 5c illustrates a flowchart of a sensing and communication node constructing an array signal based on frequency domain signals;

FIG. 5d illustrates a flowchart of a sensing and communication node constructing an array signal based on channel estimation results;

FIG. 5e illustrates a flowchart of a sensing and communication node constructing an array signal based on delay estimation results;

FIG. 6 illustrates a flowchart of a method of receiving or transmitting a signal according to an embodiment of the present disclosure;

FIG. 7 illustrates a schematic diagram of a structure of a sub-array according to an embodiment of the present disclosure;

FIG. 8 illustrates a schematic diagram of a sensing and communication node performing angle estimation according to an embodiment of the present disclosure;

FIG. 9 illustrates a block diagram of an example of a sensing and communication node according to an embodiment of the present disclosure;

FIG. 10 illustrates a block diagram of another example of a sensing and communication node according to an embodiment of the present disclosure;

FIG. 11 illustrates a flow diagram of a method performed by a user equipment according to an embodiment of the present disclosure;

FIG. 12 illustrates a flow diagram of a method performed by a base station according to an embodiment of the present disclosure;

FIG. 13 illustrates a block diagram of a terminal (or a user equipment (UE)), according to embodiments of the present disclosure; and

FIG. 14 illustrates a block diagram of a base station, according to embodiments of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which may be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

The technical solutions of the embodiments of the present disclosure may be applied to various communication systems, such as a global system for mobile communications (GSM) systems, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an universal mobile telecommunication system (UMTS), a global interoperability for microwave access (WiMAX) communication system, a fifth generation (5G) system, or a new radio (NR), etc. In addition, the technical solutions of the embodiments of the present disclosure may be applied to future-oriented communication technologies.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beam forming, massive multiple-input multiple-output (MIMO), full-dimensional MIMO (FD-MIMO), array antenna, analog beam forming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

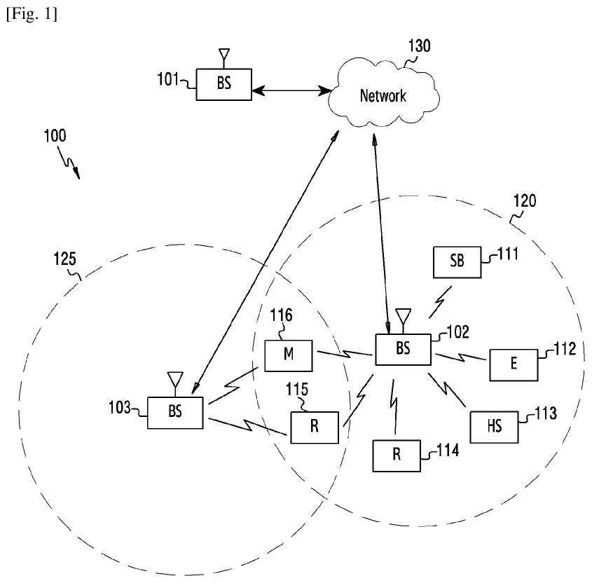

FIG. 1 illustrates an example wireless network 100 according to various embodiments of the present disclosure. The embodiment of the wireless network 100 shown in FIG. 1 is for illustration only. Other embodiments of the wireless network 100 may be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” may be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” may be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes may be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

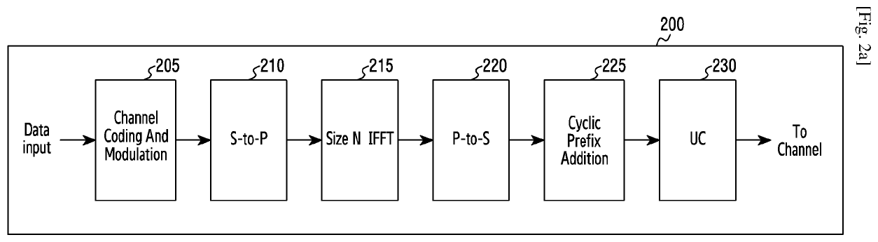

FIG. 2a illustrates an example wireless transmission path according to the present disclosure.

In the following description, the transmission path 200 may be described as being implemented in a gNB, such as gNB 102. However, it should be understood that the transmission path 200 may be implemented in a UE.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

Each of gNBs 101-103 may implement a transmission path 200 similar to that for transmitting to UEs 111-116 in the downlink. Similarly, each of UEs 111-116 may implement a transmission path 200 for transmitting to gNBs 101-103 in the uplink.

FIG. 2b illustrates an example wireless reception path according to various embodiments of the present disclosure;

In the following description, the reception path 250 may be described as being implemented in a UE, such as UE 116. However, it should be understood that the reception path 250 may be implemented in a gNB. In some embodiments, the reception path 250 is configured to support codebook designs and structures for systems with 2D antenna arrays as described in embodiments of the present disclosure.

The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency domain signals. The Parallel-to-Serial block 275 converts the parallel frequency domain signal into a sequence of modulated data symbols. The channel decoding and demodulation block 280 demodulates and decodes the modulated symbols to recover the original input data stream.

Each of gNBs 101-103 may implement a reception path 250 similar to that for receiving from UEs 111-116 in the uplink. Similarly, each of UEs 111-116 may implement a reception path 250 for receiving from gNBs 101-103 in the downlink.

Each of the components in FIGS. 2a and 2b may be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms may be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b may be combined, further subdivided or omitted, and additional components may be added according to specific requirements. Furthermore, FIGS. 2a and 2b are intended to illustrate examples of types of transmission and reception paths that may be used in a wireless network. Any other suitable architecture may be used to support wireless communication in a wireless network.

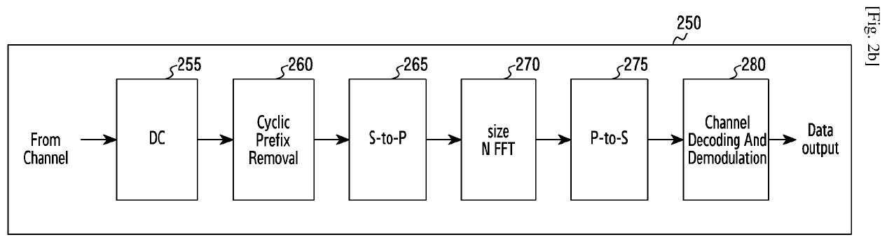

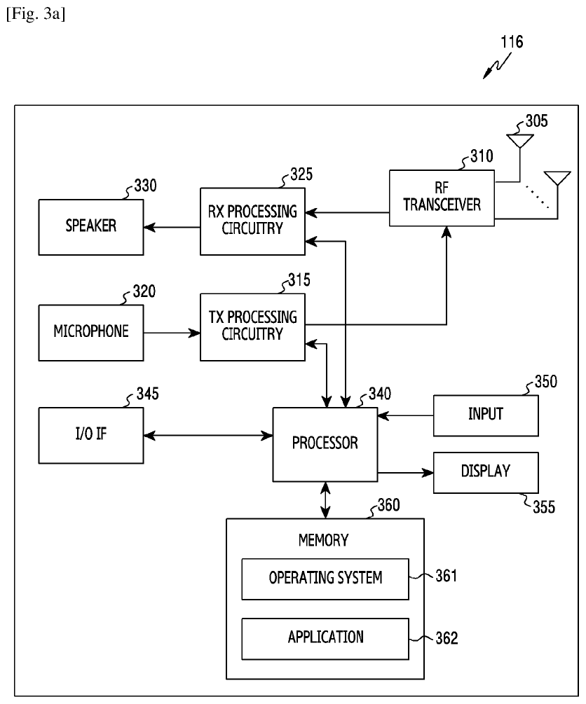

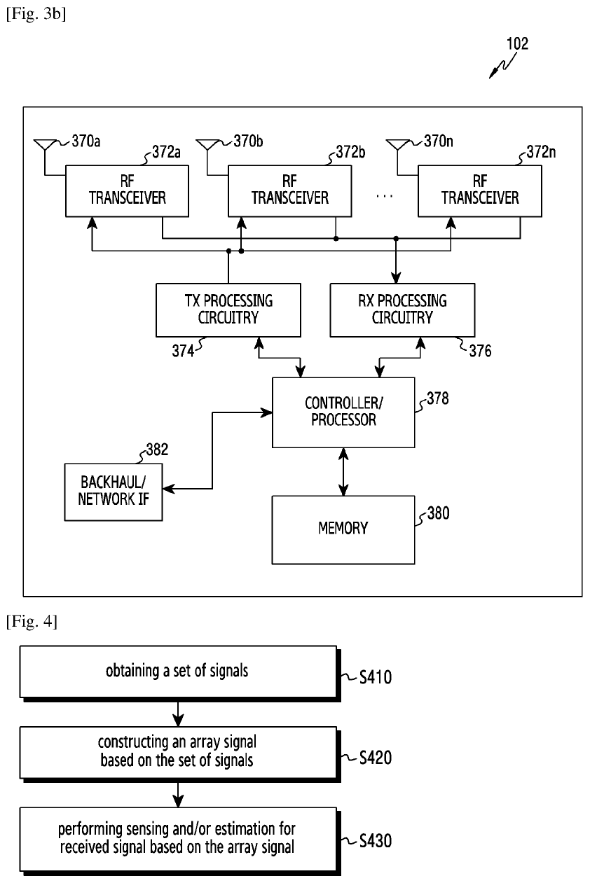

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes may be made to FIG. 3a. For example, various components in FIG. 3a may be combined, further subdivided or omitted, and additional components may be added according to specific requirements. As a specific example, the processor/controller 340 may be divided into a plurality of processors, such as one or more central processing units (CPUs) and one or more graphics processing units (GPUs). Furthermore, although FIG. 3a illustrates that the UE 116 is configured as a mobile phone or a smart phone, UEs may be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as high-layer wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

It is understood that the solutions provided by the embodiments of the present disclosure may be applicable to, but not limited to, the wireless network described above.

In a communication system, a transmission from a base station to a user equipment (UE) is referred to as a downlink transmission, and a transmission from a UE to a base station is referred to as an uplink transmission.

With the advancement of science and technology, there is an increasing variety of communication devices. In addition to traditional devices such as a cell phone and a computer, the communication devices may also include a mobile robot, such as a self-driving vehicle, a drone, etc. This type of mobile device is generally required to have the ability to accurately position or be positioned so that it can accurately identify and react to the current situation, i.e., have a positioning capability similar to that provided by radar technology. A direct way may be that a radar module is equipped in the communication device, however, in recent years, the working frequency band of a communication system is gradually developing to a higher frequency band, the communication band is also gradually close to the radar band, the resulting interference and resource conflict between the communication system and a radar system will not be avoided. One concept to solve this problem may be to consider a fusion system of communication and radar, called communication and sensing integration technology, to further enhance the function of the communication system as well as to improve the spectrum efficiency. Currently, both industry and academia are considering the communication and sensing integration as one of key technologies for a future communication system.

A core concept of the communication and sensing integration is to use the same set of hardware devices to realize a function of sensing surrounding environment with as little resource overhead as possible, while ensuring a basic communication function. For example, a communication node is also equipped with a function of sensing, the content of sensing includes a distance, an orientation, a speed and even a type of an object in the surrounding environment. Unlike the technology of locating an access terminal in the traditional communication system, the communication and sensing integration technology may also sense a variety of information about a non-access object, which greatly increases the ability of the communication system to dynamically adjust its working states (e.g., scheduling, beam management, early warning of the access terminal, etc.) according to the surrounding environment. However, the existing communication and sensing integration node cannot achieve more accurate sensing and/or estimation for received signal, and there is also a problem of high resource overhead in sensing and/or estimation for received signal.

With respect to this, the present disclosure relates primarily to a sensing function and/or a communication function of a communication and sensing integration node, and proposes a communication and sensing integration node and a method performed by the communication and sensing integration node, the communication and sensing integration node and the method performed by the communication and sensing integration node according to embodiments of the present disclosure are capable of achieving more accurate sensing and/or estimation for received signal, or, the communication and sensing integration node and the method performed by the communication and sensing integration node according to embodiments of the present disclosure enable more accurate sensing (e.g., achieve more accurate angle estimation) and/or estimation for received signal with less resource overhead. Hereinafter, the communication and sensing integration node is referred to as a sensing and communication node, and the sensing and communication node may specifically be any wireless communication device, e.g., a base station, a terminal device, a sidelink device, etc.

The most widely used communication system is a 3GPP protocol-based system, e.g., a 4G communication system such as the LTE and the LTE-A, and a 5G communication system such as the NR, and the signal waveforms used in these communication systems are OFDM modulation-based waveforms. Considering forward compatibility, the OFDM communication signal may be used, for example, as a signal for sensing and/or estimation for received signal. Specifically, the signal may be a physical signal and/or a physical channel that may be used for sensing purposes, for example, when the sensing and communication node is a base station, the signal may be a downlink reference signal or a downlink physical channel, etc., and when the sensing and communication node is a terminal, the signal may be an uplink reference signal or an uplink physical channel, etc. The signal sent by the sensing and communication node is reflected by a target reflector and then re-received by the sensing and communication node in the form of echo, and a distance, a speed, an orientation and other sensing information of the target object may be sensed by the signal processing of the echo signal.

For a 5G or future communication system, the number of RF links in an antenna panel is generally smaller than the actual number of array elements in the antenna panel, especially in a millimeter wave band or higher, so a baseband processing unit cannot directly obtain a digital received signal of each array element, which limits application of an algorithm that may achieve angle estimation of high accuracy, such as a MUSIC algorithm based on subspace decomposition, an ESPRIT algorithm etc.

Embodiments of the present disclosure provide a method based on signal accumulation by which the requirement for the number of RF links of a device for high-precision sensing and/or estimation for received signal is reduced, for example, a direction of arrival (DOA) of a signal is determined by the method based on the signal accumulation.

Hereinafter, the method performed by a sensing and communication node of the embodiments of the present disclosure is described with reference to FIGS. 4 through 10.

FIG. 4 illustrates a flow diagram of a method performed by a sensing and communication node provided by an embodiment of the present disclosure.

According to an embodiment, the sensing and communication node may refer to a node described above that has both sensing and communication functions, for example, a base station, a user equipment, or a sidelink device. The sensing and communication node may include a receiving antenna panel. For example, the sensing and communication node may operate in a millimeter wave band or a higher frequency band.

Referring to FIG. 4, in step S410, the sensing and communication node may obtain a set of signals. Here, a signal in the set of signals may refer to a signal received by the sensing and communication node, such as the signal described above. In the present disclosure, the signal in the obtained set of signals may be used for sensing and/or estimation for received signal. For example, in the case of performing sensing, the signal in the obtained set of signals may be a sensing signal for sensing. In the case of performing estimation for received signal, the signal in the obtained set of signals may be a communication signal for estimation for received signal. In the case of performing both sensing and estimation for received signal, the signal in the obtained set of signals may be a sensing and communication signal for both sensing and estimation for received signal. The above examples are only exemplary, and the names of the signal involved in the present disclosure are not limited to those and may be different depending on application scenario, and the signal received/obtained in the present disclosure may be used for both sensing and estimation for received signal, etc.

For example, the obtained set of signals is obtained based on signals received by a single sub-array or multiple sub-arrays of the receiving antenna panel of the sensing and communication node, wherein the sensing and communication node may obtain signals in the set of signals by adjusting weights of array elements of the sub-array(s).

It should be noted that the obtained set of signals may include one or more sets of signals. For example, in the case where the sensing and communication node uses one sub-array, the obtained set of signals may include one set of signals received by that one sub-array, while in the case where the sensing and communication node uses multiple sub-arrays, the obtained set of signals may include multiple sets of signals received by that multiple sub-arrays, as will be described specifically below.

In step S420, the sensing and communication node may construct an array signal based on the set of signals. The constructed array signal may refer to an array signal used to perform sensing and/or receive signal estimation. It should be noted that the array signal of the present disclosure is an array signal that is constructed based on the received signals and has the same or similar function (such as performing sensing and/or estimation for received signal) as an array signal obtained by direct reception.

In step S430, the sensing and/or estimation for received signal is performed based on the constructed array signal. In the present disclosure, the sensing may mean sensing the surrounding environment, or sensing a target in the environment, etc.

In the method of FIG. 4, the sensing and communication node may obtain the set of signals based on signals received by a single sub-array or multiple sub-arrays of the receiving antenna panel, and the number of antenna array elements in the antenna subarray used to receive the set of signals is less than or equal to the number of RF links, so that the dimensionality of the signals received by the sensing and communication node is less than or equal to the dimensionality of the RF links, and the sensing and communication node may not need to use a compressed sensing algorithm such as an algorithm with higher complexity to determine the channel information.

Performing sensing and/or estimation for received signal based on the obtained set of signals enables to perform more accurate sensing and/or estimation for received signal with less resource consumption, and the requirement for the number of RF links is reduced.

In the following, the specific operations involved in the above steps will be described in more detail in connection with various embodiments.

The method according to FIG. 4 may perform sensing, or perform estimation for received signal, or perform both sensing and estimation for received signal.

Hereinafter, the relevant contents of performing sensing according to embodiments of the present disclosure are first described. In the following, the relevant contents of the sensing method of the embodiments of the present disclosure are described by taking performing angle estimation as an example in terms of performing sensing. However, performing sensing in the present disclosure is not limited to performing angle estimation, but may also include, for example, performing distance estimation, speed estimation, and the like of a target.

According to the method shown in FIG. 4, the sensing and communication node may obtain resource configuration information (such as information relating to time domain and/or frequency domain resources for obtaining signals for sensing and/or estimation for received signal). The sensing and communication node determines a set of antenna array element weights (the set of antenna array element weights may represent a set of weights from which weights are selected to configure array elements). The sensing and communication node, based on the resource configuration information and the set of antenna array element weights, receives a signal in the set of signals for sensing and/or estimation for received signal. Therein, the sensing and communication node selects different weights from the set of antenna array element weights to configure the subarray for receiving different signals in the set of signals. The adjustment to the weights may include adjusting at least one of a phase and an amplitude of the array element. Specifically, each signal in the set of signals is received by the sub-array configured with different weights, respectively. Note that the array elements of the sub-array are configured with different weight vectors when at least two signals in the set of signals are received, wherein the number of weights in the weight vector corresponds to the number of array elements of the sub-array, and the weight vectors for configuring all the array elements are required to be different, while the weights configured for individual array elements may be the same or different. In the present disclosure, the set of antenna array element weights may store weights in the form of a weight vector, or the set of antenna array element weights may store multiple weights, and one group of weights is selected from the set of antenna array element weights when one signal is received while another group of weights is selected from the set of antenna array element weights when another signal is received, with the two groups of weights being not completely identical. The above examples are only exemplary and the present disclosure is not limited thereto.

For example, when the sensing and communication node is a terminal or sidelink device, the set of signals may be obtained on the time domain and/or frequency domain resources configured at a base station, and each signal in the set of signals is received by the sensing and communication node through a sub-array configured with different weights, and the set of signals may be a collection of signals used for sensing and/or estimation for received signal. Specifically, the sensing and communication node obtains the set of signals based on the single sub-array or multiple sub-arrays of the receiving antenna panel. Further, the sensing and communication node constitutes an array signal based on the obtained set of signals.

According to the embodiments of the present disclosure, in the method shown in FIG. 4, the sensing and communication node may obtain the set of signals by self-transmitting and self-receiving (i.e., without receiving the resource configuration information). Specifically, the sensing and communication node determines a required number of signals and a set of antenna array element weights, and the sensing and communication node receives signals in the set of signals by self-transmitting and self-receiving based on the required number of signals and the set of antenna array element weights. Therein, the sensing and communication node selects different weight vectors from the set of antenna array element weights to configure the sub-array for receiving different signals in the set of signals. For example, each signal in the set of signals is received separately by the sub-array configured with different weights. Note that the array elements of the sub-array are configured with different weight vectors when at least two signals in the set of signals are received, wherein the weight vectors for configuring all the array elements are required to be different, and the weights configured for individual array elements may be the same or different.

For example, when the sensing and communication node is a base station, it may transmit a signal on its own configured time domain and/or frequency domain resources and receive an echo signal of the signal as a signal in the set of signals. Wherein, time domain and/or frequency domain resources configured by the base station itself means resources that are available for the base station to transmit signals or idle resources that are not being used for communication. Each signal in the set of signals is received by the sensing and communication node through the sub-array configured with different weights, and the set of signals may be a collection of signals used for sensing and/or estimation for received signal. Specifically, the sensing and communication node obtains the set of signals based on the single sub-array or multiple sub-arrays of the receiving antenna panel. Further, the sensing and communication node constitutes an array signal based on the obtained set of signals.

According to the method shown in FIG. 4, the number of signals in the set of signals is less than or equal to the number of signals required by the sensing and communication node, wherein the number of signals required by the sensing and communication node is related to the number of antenna arrays in the antenna sub-array, and the more the number of antenna array elements in the antenna sub-array is, the more the number of signals required is. When the required number of signals is equal to the number of antenna array elements, the sensing and communication node may achieve optimal angle estimation performance based on the obtained set of signals, and when the required number of signals is less than the number of antenna array elements, the sensing and communication node may still achieve optimal angle estimation performance based on the obtained set of signals under certain sensing conditions, such as performing angle estimation at a specific angle range. Thus, the sensing and communication node may determine the number of signals it requires based on the sensing conditions.

When the sensing and communication node is a user equipment, the signal in the obtained set of signals may be at least one of an echo signal of an uplink signal, a downlink signal, and a new signal, wherein the downlink signal at least includes one of a demodulation reference signal, a channel state information reference signal, a synchronization signal, a physical downlink shared channel, and a physical downlink control channel. The uplink signal at least includes one of a demodulation reference signal, a sounding reference signal, a physical uplink shared channel, and a physical uplink control channel. The new signal at least includes a signal in which a reference signal is mapped to a configured frequency domain resource in accordance with an interval. The new signal may be obtained, for example, by mapping the reference signal to the configured frequency domain resource (such as a subcarrier) in a uniform mapping manner, where the reference signal may be an arbitrary signal. The reference signal mapped to the frequency domain resource may be one or more elements generated according to a sequence, or may be a plurality of signals.

When the sensing and communication node is a base station, the signal in the acquired set of signals may be at least one of an echo signal of a downlink signal, an uplink signal, and a new signal, wherein the downlink signal at least includes one of a demodulation reference signal, a channel state information reference signal, a synchronization signal, a physical downlink shared channel, and a physical downlink control channel. The uplink signal at least includes one of a demodulation reference signal, a sounding reference signal, a physical uplink shared channel, and a physical uplink control channel. The new signal at least includes a single in which a reference signal is mapped to a configured frequency domain resource in accordance with an interval. The new signal may be obtained, for example, by mapping the reference signal to the configured frequency domain resource (such as a subcarrier) in a uniform mapping manner, where the reference signal may be an arbitrary signal. The reference signal mapped to the frequency domain resource may be one or more elements generated according to a sequence, or may be a plurality of signals.

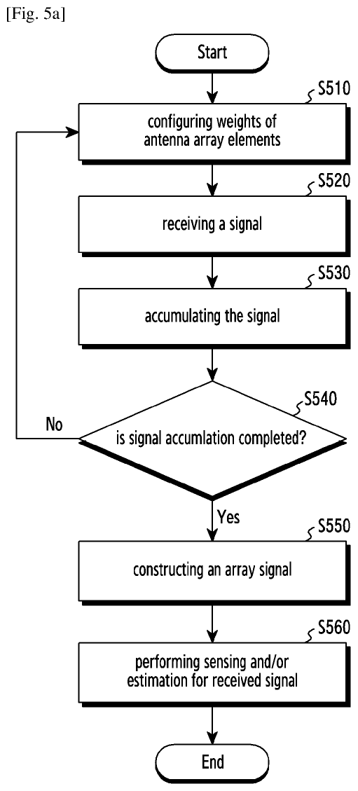

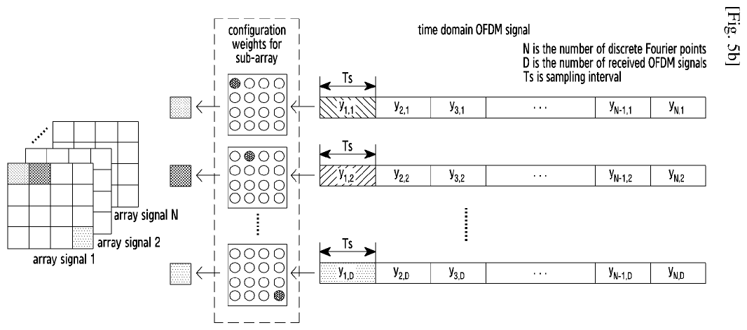

FIG. 5a illustrates a flow diagram of a method performed by a sensing and communication node according to another embodiment of the present disclosure. FIG. 5a illustrates a specific process for a sensing and communication node to receive a set of signals on time and/or frequency domain resources, constitute an array signal based on the set of signals and perform sensing and/or estimation for received signal.

In step S510, the sensing and communication node selects a group of antenna array element weights (i.e., a weight vector) from a set of antenna array element weights to configure weights of array elements of an antenna sub-array.

In step S520, the sensing and communication node receives a signal based on the antenna configured with the antenna array element weights within configured time and/or frequency domain resources. For example, when the sensing and communication node is a base station, the time domain and/or frequency domain resources are configured by the sensing and communication node itself, and when the sensing and communication node is a user equipment, the time domain and/or frequency domain resources may be configured by other nodes (such as a base station).

In step S530, the sensing and communication node accumulates the signal received at step S520 for constituting the set of signals.

In step S540, the sensing and communication node determines whether the signal accumulation is completed. Specifically, the sensing and communication node determines whether the reception of signals is completed within the configured time and/or frequency domain resources. The amount of the configured time and/or frequency domain resources may determine the number of signals that can be obtained by the sensing and communication node. The signal accumulation may be considered as completed if the reception of signals on all resources is completed.

If the determination result is ‘yes’, the sensing and communication node obtains the set of signals, and if the determination result is ‘no’, the sensing and communication node proceeds to step S510, i.e., continues to receive a signal in the manner described above.

In the embodiments of the present disclosure, signals may be received by a plurality of sub-arrays to obtain a plurality of sets of signals, and the final set of signals is formed based on the plurality of sets of signals.

In step S550, the sensing and communication node constructs an array signal based on the set of signals.

In step S560, the sensing and communication node performs sensing and/or estimation for received signal, for example, DOA estimation, based on the array signal obtained at step S550.

According to an embodiment, in step S510, the sensing and communication node may obtain the set of signals based on signals received based on different antenna array element weights on the configured time domain resources.

For example, the sensing and communication node may obtain the set of signals by configuring different array element weights for the single sub-array or multiple subarrays of the receiving antenna panel to receive signals, on the configured time domain resource. Wherein, the adjustment to the weights may be an adjustment to a phase of an array element only (an adjustment to phase shift of a phase shifter linked to the array element), an adjustment to an amplitude of the array element only (an adjustment to a mode of a low-noise amplifier linked to the array element), or an adjustment to both the amplitude and the phase of the array element, such as, but not limited to, an adjustment using a windowing function on array. The sensing and communication node may select the antenna array element weights in the set of antenna array element weights, where the set of antenna array element weights may be generated by the sensing and communication node. The advantage of the approach of generating the set of antenna array element weights by the sensing and communication node itself is that the sensing and communication node may adjust the set of weights as required, thereby improving the performance of the sensing and communication node in sensing and/or estimation for received signal. In addition, the sensing and communication node may also receive configuration information about the set of antenna array element weights from other nodes. For example, when the sensing and communication node is a terminal, another node (e.g., a base station) may configure the set of antenna array element weights for the sensing and communication node by downlink control information, high-layer signaling (e.g., RRC signaling, MAC signaling, etc.).

For another example, the sensing and communication node may obtain information (such as index information) for indicating the set of antenna array element weights, and determine the indicated set of antenna array element weights from pre-obtained at least one set of antenna array element weights based on the information. For example, when the sensing and communication node is a terminal or sidelink device, the base station may configure index information for the set of antenna array element weights to be used by the sensing and communication node via at least one of downlink control information and high-layer signaling (e.g., RRC signaling, MAC signaling, etc.), wherein the index information may be used to indicate a specific set of weights in the plurality sets of weights (such as the set of antenna array element weights to be used by the sensing and communication node), and the plurality sets of weights may be known to the sensing and communication node and another node (e.g., a base station), such as pre-configured.

The advantage of selecting the set of antenna array element weights by means of configuration by another node (such as a base station) is that different sets of weights may be applicable to different scenarios, and configuration by another node allows selection of a set of weights adapted to a corresponding scenario, improving the performance of the sensing and communication node in sensing and/or estimation for received signal.

According to an embodiment, in step S520, the sensing and communication node receives a signal within the configured time and/or frequency domain resources based on the antenna configured with the antenna array element weights. The configured unit of the time domain resource may be a time domain symbol, and the sensing and communication node receives the signal based on the antenna the antenna configured with the antenna array element weights, on different time domain symbols of the same time slot or consecutive time slots.

For example, when the sensing and communication node receives L configured time domain symbols Tᵢ, i=1, . . . , L, the sensing and communication node selects a weight vector wᵢ, i=1, . . . , D from the set of antenna array element weights {wᵢ}, i=1, . . . , D (where, wᵢ denotes a weight vector for array elements in a sub-array used to receive the time domain symbol Tᵢ) to configure array elements of an antenna sub-array, where, D is the number of weight vectors in the set of antenna array element weights, and the number of the weight vectors is not less than the number of array elements in the antenna sub-array. The weight configured for each array element eⱼ, j=1, . . . , D in the sub-array is wⱼ, j=1, . . . , D, where wⱼ={wⱼ}, j=1, . . . , D, i=1, . . . , D. Next, the sensing and communication node receives the time domain symbol Tⱼ, i=1, . . . , L by the antenna arrays configured with the weights, where L≤D. Specifically, when the number L of time domain symbols configured by the sensing and communication node for receiving the set of signals is smaller than the number D of weight vectors in the set of antenna array element weights, the sensing and communication node may configure the antenna array elements by selecting L weight vectors from the configured set of antenna array element weights, e.g., selecting based on correlation coefficients between weight vectors. Alternatively, when the number L of time domain symbols configured by the sensing and communication node for receiving the set of signals is equal to the number D of weight vectors in the set of antenna array element weights, the sensing and communication node may configure the antenna array elements by using D weight vectors in the set of antenna array element weights in any order within the D time domain symbols.

According to an embodiment, the used set of antenna array element weights may include multiple weight vectors, and the sensing and communication node may calculate a correlation coefficient between every two weight vectors included in the set of antenna array element weights and select a weight vector based on the correlation coefficient.

For example, when the number L of time domain symbols configured by the sensing and communication node for receiving the set of signals is less than or equal to the number of weight vectors in the set of antenna array element weights, the sensing and communication node may perform selection of a weight vector for antenna array elements based on correlation coefficients P_{i,j}, i=1, . . . , D, j=1, . . . , D, i≠j between D weight vectors for antenna array elements when receiving a time domain symbol Tᵢ, i=1, . . . , L. For example, when the sensing and communication node receives time domain symbols Tᵢ and Tⱼ, the correlation coefficient

$$ρ = \frac{cov ( {W}_{i} , {W}_{j} )}{{σ}_{i} {σ}_{j}}$$

between the configured weight vectors wᵢ and wⱼ for antenna array elements should satisfy 0≤ρ<α, where i=1, . . . , N, j=i=1, . . . , Nₛ, i≠j, cov(wᵢ, wⱼ) is the covariance of wᵢ and Wⱼ, σᵢ and σⱼ are the variances of w₁ and w₂, respectively, and a is a set threshold, which is related to the required sensing accuracy of the sensing and communication node. For example, the higher the sensing accuracy required is, the lower the value of the threshold should be. A specific embodiment may be that the sensing and communication node randomly selects a weight vector w₁ from the set of antenna array element weights (D weight vectors for antenna array elements) as weight configuration for the antenna array elements when receiving a time domain symbol T₁, and selects a weight vector from the set of antenna array element weights other than the weight vector w₁ that is least correlated with w₁ i.e., a weight vector w₂ that has the lowest correlation coefficient ρ_{i,j}, j=1, . . . , D with w₁ when receiving a next time domain symbol T₂, and so on. L weight vectors for antenna array elements are selected from the set of antenna array element weights as the weight configurations for the antenna array elements when receiving L time domain symbols.

Alternatively, the sensing and communication node arbitrarily selects L weight vectors for antenna array elements from the set of antenna array element weights, and uses the L weight vectors for antenna array elements as weight configurations for the antenna array elements when receiving L time domain symbols. It is noted that the sensing and communication node does not repeatedly select the same weights in the set of antenna array element weights to receive signals on the configured time domain symbols. The beneficial effect of this implementation is that online computation of weights is avoided by pre-configuring the sensing and communication node with a plurality of weight vectors with low correlation coefficients, fast and efficient data accumulation may be achieved within a plurality of time domain resources to obtain the set of signals, and sensing and/or signal estimation of high accuracy may be achieved based on the set of signals.

Alternatively, when the number L of time domain symbols configured by the sensing and communication node for receiving the set of signals is equal to the number D of weight vectors in the set of antenna array element weights, the sensing and communication node may also configure the antenna array elements using the D weight vectors in the set of antenna array element weights in any order within the D time domain symbols.

For example, when the sensing and communication node receives a time domain symbol Tᵢ, i=1, . . . , D, antenna array elements are configured using weights Wᵢ, i=1, . . . , D. As shown in Table 1, when the sensing and communication node receives a time domain symbol T₁, it configures array elements of a single sub-array or multiple sub-arrays of the receiving antenna panel with weights w₁ and a signal s₁ is received by the single sub-array or multiple sub-arrays of the receiving antenna panel. At a next time domain resource T₂, the array elements of the single sub-array or multiple sub-arrays of the receiving antenna panel are configured with weights w₂, and a signal s₂ is received by the single sub-array or multiple sub-arrays of the receiving antenna panel. By analogy, on the time domain resources of Nₛ configured time domain symbols, the sensing and communication node configures the single sub-array or multiple sub-arrays of the receiving antenna panel with weights wᵢ, i=1, . . . , Nₛ, where the weights wᵢ, i=1, . . . , Nₛ configured within the Nₛ time domain symbols are different. The advantage of configuring the weights in this way is that Nₛ signals that are all unrelated are obtained within Nₛ time domain resources based on different weights for antenna array elements, i.e., a set of signals, which may further be used to construct an array signal for accurate sensing and/or estimation for received signal, e.g., angle estimation.

TABLE 1

| time domain | time domain | time domain | | time domain |
|---|---|---|---|---|
| symbol T₁ | symbol T₂ | symbol T₃ | . . . | symbol T_{N}_{ₛ} |
| weights W₁ | weights W₂ | weights W₃ | . . . | weights W_{N}_{ₛ} |

According to an embodiment, in step S550, the sensing and communication node constructs an array signal based on the set of signals. Specifically, the sensing and communication node may construct the array signal in at least one of the following ways: based on time domain signals, based on frequency domain signals, based on channel estimation results, based on time delay estimation results. Further, the sensing and communication node may calculate a sample covariance matrix of the constructed array signal based on the array signal.

Taking an example that the receiving antenna panel is a uniform area array, guiding vectors of the X-axis and Z-axis may be expressed as:

$${a}_{X} = [ \begin{matrix}{e}^{( - \frac{{N}_{X}}{2} ) η} \\ {e}^{( - \frac{{N}_{X}}{2} + 1 ) η} \\ ⋮ \\ {e}^{( \frac{{N}_{X}}{2} - 1 ) η}\end{matrix} ]$$

$${a}_{Z} = [ \begin{matrix}{e}^{( \frac{{N}_{Z}}{2} - 1 ) ζ} \\ {e}^{( \frac{{N}_{Z}}{2} - 2 ) ζ} \\ ⋮ \\ {e}^{( - \frac{{N}_{Z}}{2} ) ζ}\end{matrix} ]$$

where

$$η = j \frac{2 π}{λ} {d}_{X} cos {β}_{X}^{′} ζ = j \frac{2 π}{λ} {d}_{Z} cos {β}_{Z} ,$$

β_{X} and β₂ are off-axis angles of DOA of the signal in the X-axis and Z-axis, respectively, d_{X} and d_{Z} are spacing between the antenna elements in the X-axis and Z-axis directions, respectively, and λ is a wavelength, and N_{X} and N_{Z} are the numbers of the antenna elements in the X-axis and Z-axis directions, respectively. Assuming that there are K angles of a target object to be estimated, the two-dimensional guiding matrix corresponding to the K angles may be expressed as a one-dimensional guiding vector v=vec(a_{X} ⊗a_{Z}), where ⊗ is a Kronecker product, the guiding matrix corresponding to the K angles may be expressed as A=[v₁, v₂, . . . , v_{K}], wherein vᵢ, i=1, 2, . . . , K is a guiding vector of the angle

$$( {β}_{X}^{i} , {β}_{Z}^{i} ) ,$$

and the received signal may be expressed as y=Ax+n, where x is an antenna received signal vector and n is a noise vector.

According to an embodiment, the sensing and communication node may construct the array signal based on time domain signals. The sensing and communication node may construct a time domain array signal, i.e., the constructed array signal, based on at least one sample point of each signal in a set of signals.

FIG. 5b illustrates a flowchart of a sensing and communication node constructing an array signal based on time domain signals. The sensing and communication node receives D OFDM signals, i.e., a set of signals in the time domain {y_{i,j}}, i=1, . . . , N_{FFT}, j=1, . . . , D, where y_{i,j} is the i, i=1, . . . , N_{FFT} sample point of the time domain OFDM signal received in the j, j=1, . . . , D time domain symbol, where N_{FFT} is the number of Discrete Fourier Transform (DFT) points, and the interval between the time domain sample points is Tₛ, each sample point may be considered as a snapshot data. An array signal may be constructed based on a single sample point or multiple sample points of the set of signals in the time domain. The array signal may be constructed based on the single sample point or multiple sample points of the set of signals in the time domain in the order of acquisition of the signals in the set of signals. For example, a time domain array signal may be obtained based on individual sample points of D OFDM signals, i.e.,

$${y}_{i} = {[ {y}_{i , 1} {y}_{i , 2} … {y}_{i , D} ]}^{T} = [ \begin{matrix}{W}_{1}^{T} {Ax}_{i , 1} + {n}_{i , 1} \\ {W}_{2}^{T} {Ax}_{i , 2} + {n}_{i , 2} \\ ⋮ \\ {W}_{D}^{T} {Ax}_{i , D} + {n}_{i , D}\end{matrix} ] , i = 1 , … , {N}_{FFT}$$

where Wⱼ, j=1, . . . , D are the weights configured for the antenna array elements in the j, j=1, . . . , D time domain symbol, for example, the weights Wⱼ, j=1, . . . , D may be an amplitude vector that amplifies the m array element as \grave{C}. A is the guiding matrix, x_{i,j}, i=1, . . . . L, j=1, . . . , D is a vector of signals incident at K different angles, and nᵢ, i=1, . . . , D is the noise. Optionally, the array signal may also be constructed by randomly arranging the sample points. Further, a time domain sample covariance matrix of the time domain array signal may be obtained by using L sample points, L≤N_{FFT}, and is written as

$${\hat{R}}_{y} = \frac{1}{L} {\sum }_{i}^{L} {{y}_{i} ( {y}_{i} )}^{H} .$$

The sensing and communication node performs sensing and/or estimation for received signal based on the time domain sample covariance matrix \hat{R}_{y} of the array signal. For example, the sensing and communication node performs an eigenvalue decomposition of the time domain sample covariance matrix \hat{R}_{y} of the array signal, and uses an orthogonality of a noise subspace and a signal subspace to construct a spectral function to perform searching for a spectral peak, to achieve DOA estimation of high accuracy.

According to an embodiment, the sensing and communication node may also construct the array signal based on frequency domain signals. The sensing and communication node may obtain a set of signals in a frequency domain by performing Fourier transform on a set of signals in a time domain. The sensing and communication node may construct a frequency domain array signal, i.e., the constructed array signal, based on at least one sample point of each signal in the set of signals in the frequency domain.

FIG. 5c illustrates a flowchart of a sensing and communication node constructing an array signal based on frequency domain signals. The sensing and communication node performs discrete Fourier transform on the above received OFDM signals (the set of signals in the time domain) to obtain a set of signals in the frequency domain {Y_{i,j}}, i=1, . . . , N_{FFT}, j=1, . . . , D, where N_{FFT} is the number of discrete Fourier points, the interval between the time domain sample points is Tₛ, the interval between the frequency domain sample points is Δf (subcarrier interval), and each sample point may be considered as a snapshot data. An array signal may be constructed based on a single sample point or multiple sample points of the set of signals in the frequency domain. The array signal may be constructed based on the single sample point or multiple sample points of the set of signals in the frequency domain in the order of acquisition of the signals in the set of signals. For example, a frequency domain array signal may be obtained based on individual frequency domain sample points of the set of signals in the frequency domain, i.e., Yᵢ=[Y_{i,1} Y_{i,2} . . . . Y_{i,D}]^{T}, i=1, . . . , L. Optionally, the array signal may be constructed by randomly arranging the sample points. Further, a frequency domain sample covariance matrix of the frequency domain array signal may be obtained by using Z frequency domain sample points, L≤N_{FFT}, and is written as

$${\hat{R}}_{Y} = \frac{1}{L} {\sum }_{i}^{L} {{Y}_{i} ( {Y}_{i} )}^{H} .$$

The sensing and communication node performs sensing and/or estimation for received signal based on the frequency domain sample covariance matrix \hat{R}_{y} of the frequency domain array signal. For example, the sensing and communication node performs an eigenvalue decomposition of the sample covariance matrix \hat{R}_{y} of the frequency domain array signal and uses orthogonality between a noise subspace and a signal subspace to construct a spectral function to perform searching for spectral peak, to achieve DOA estimation of high accuracy.

According to an embodiment, the sensing and communication node may also construct the array signal based on channel estimation results. The sensing and communication node may obtain a set of signals in a frequency domain by performing Fourier transform on a set of signals in a time domain, perform channel estimation on the set of signals in the frequency domain to obtain a channel estimated set of signals, and construct a channel estimated array signal, i.e., the constructed array signal, based on at least one sample point of each signal in the channel estimated set of signals.

FIG. 5d illustrates a flowchart of a sensing and communication node constructing an array signal based on channel estimation results. The sensing and communication node performs channel estimation on the above set of signals in the frequency domain and uses a result of the channel estimation to construct a channel array signal. Specifically, the channel estimation may be performed in the time domain or in the frequency domain. For example, the channel estimation is performed in the frequency domain, and the channel estimated set of signals is obtained by performing channel estimation on D OFDM frequency domain signals, i.e., {H_{i,j}}, i=1, . . . , N_{FFT}, j=1, . . . , D, where N_{FFT} is the number of discrete Fourier points, the interval between the time domain sample points is Tₛ, and the interval between the frequency domain sample points is Δf (subcarrier interval), and each individual sample point may be considered as one snapshot data. The array signal may be constructed based on a single sample point or multiple sample points of the channel estimated set of signals. The array signal may be constructed based on the single sample point or multiple sample points of the channel estimated set of signals in the order of acquisition of the signals in the set of signals. For example, the sensing and communication node may constitute the channel estimated array signal based on the i, i=1, . . . , N_{FFT} sample point of the channel estimated set of signals. Optionally, the array signal may be constructed by randomly arranging the sample points. Further, a sample covariance matrix of the channel array signal may be obtained by using L sample points, L≤N_{FFT}, and is written as

$${\hat{R}}_{H} = \frac{1}{L} {\sum }_{i}^{L} {{H}_{i} ( {H}_{i} )}^{H} .$$

The sensing and communication node performs sensing and/or estimation for received signal based on the sample covariance matrix \hat{R}_{H} of the channel array signal. For example, the sensing and communication node performs an eigenvalue decomposition of the channel estimated sample covariance matrix \hat{R}_{H}, and uses orthogonality between a noise subspace and a signal subspace to construct a spectral function to perform searching for a spectral peak, to achieve DOA estimation of high accuracy.

According to an embodiment, the sensing and communication node may also construct the array signal based on time delay estimation results. The sensing and communication node may obtain a set of signals in a frequency domain by performing Fourier transform on a set of signals in a time domain, perform channel estimation on the set of signals in the frequency domain to obtain a channel estimated set of signals, perform Fourier inverse transform on the channel estimated set of signals to obtain a time delay estimated set of signals, and construct a time delay estimated array signal, i.e., the constructed array signal, based on at least one sample point of each signal in the time delay estimated set of signals.

FIG. 5e illustrates a flowchart of a sensing and communication node constructing an array signal based on delay estimation results. The sensing and communication node performs Inverse Discrete Fourier Transform (IDFT) on the above channel estimated set of signals to obtain delay estimation results, and uses the delay estimation results to construct the array signal. Taking performing delay estimation on OFDM symbols as an example, after Fourier inverse transform of the above channel estimation results, D time domain symbols are obtained, i.e., the time delay estimated set of signals {h_{i,j}}, i=1, . . . , N_{FFT}, j=1, . . . , D, where N_{FFT} is the number of discrete Fourier points, the interval between the time domain sample points is Tₛ, the interval between the frequency domain sample points is Δf (subcarrier interval), and each individual sample point may be considered as a snapshot data. The array signal may be constructed based on a single sample point or multiple sample points of the time delay estimated set of signals. The array signal may be constructed based on the single sample point or multiple sample points of the time delay estimated set of signals in the order of acquisition of the signals in the set of signals. For example, the sensing and communication node may constitute the time delay estimated array signal based on the i, i=1, . . . , N_{FFT} sample point of the time delay estimated set of signals, i.e., hᵢ=[h_{i,1} h_{i,2} . . . h_{i,D}]^{T}, i=1, . . . , L. Optionally, the array signal may be constructed by randomly arranging the sample points. Further, a sample covariance matrix of the time delay estimated array signal may be obtained by using L sample points, L≤N_{FFT}, and is written as

$${\hat{R}}_{h} = \frac{1}{L} {\sum }_{i}^{L} {{h}_{i} ( {h}_{i} )}^{H} .$$

Preferably, partial sample points in each time domain symbol in the time delay estimated set of signals may be selected to form the array signal, and a criterion for selecting the sample points may be to select sample points whose mode values v are greater than vₘ, where vₘ>0 is a set threshold, which may be determined dynamically or statically, and a method of the dynamic determination may find the maximum value vₘ of the mode values of all sample points at first, and the threshold is set to vₜₕ=vₘ−v₀, where v₀≥0 is a preset value, which may be determined according to the number of sample points required. If more sample points are required, a larger v₀ may be taken, and if less sample points are required, a smaller v₀ may be taken. A method of the static determination may directly set the threshold to vₜₕ=v₁, wherein v₁ is a preset value, which may be determined according to the actual scene and the number of sample points required. The sensing and communication node constructs the array signal based on an index set I={i}, of selected partial sample points, i.e.,

$${h}_{i}^{m} = {[ {h}_{i , 1} {h}_{i , 2} … {h}_{i , D} ]}^{T} , i ∈ I ,$$

where the mode value of the sample point corresponding to the index i of the index set of the sample points is greater than the set threshold, and furthermore, the time delay estimated sample covariance matrix may be obtained and written as

$${\hat{R}}_{h}^{m} = \frac{1}{L} {\sum }_{i}^{L} {{h}_{i}^{m} ( {h}_{i}^{m} )}^{H} .$$

The sensing and communication node performs sensing and/or estimation for received signal based on the time delay estimated sample covariance matrix. For example, the sensing and communication node performs an eigenvalue decomposition of the time delay estimated sample covariance matrix and uses orthogonality between a noise subspace and a signal subspace to construct a spectral function to perform searching for a spectral peak, to achieve DOA estimation of high accuracy.

According to an embodiment, in the method of FIG. 4, the sensing and communication node may obtain the set of signals based on signals received by a single subarray or multiple sub-arrays of the receiving antenna panel, and the arrangement of the antenna array elements in the sub-array(s) of the receiving antenna panel may be a one-dimensional line array, a two-dimensional area array, a circular array, or any other antenna array element arrangement. Among them, the array elements on the antenna sub-array for receiving the set of signals may be pre-configured by the sensing and communication node. For example, the antenna sub-array of the sensing and communication node is a two-dimensional area array of M×N antenna array elements, where M is the number of array elements of the sub-array in the horizontal direction and Nis the number of array elements of the sub-array in the vertical direction, and the sensing and communication node may choose to activate Mₛ array elements in the horizontal direction and Ns array elements in the vertical direction for receiving the set of signals, where Mₛ≤M, Nₛ≤N.

According to an embodiment, the sensing and communication node may obtain the set of signals on the configured resources by using a multiple antenna multiplexing manner.

For example, the method shown in FIG. 4 may include that the sensing and communication node obtains time domain and/or frequency domain resource configurations for the set of signals, and the sensing and communication node obtains the set of signals in a multiple antenna multiplexing manner (e.g., frequency division multiplexing and/or time division multiplexing) on the configured time domain and/or frequency domain resources. For example, the sensing and communication node may use multiple antennas multiplexing to obtain the set of signals based on different array element weight configurations. The speed of obtaining the set of signals may be increased by multiplexing. The advantage of the multiplexing approach is that two set of signals may be obtained using two antenna sub-arrays at the same time. If there is only one antenna sub-array, the time required to obtain two set of signals is twice as long as the multiplexing manner.

Specifically, when the sensing and communication node receives the set of signals in a multiple antenna multiplexing manner, the sensing and communication node receives the set of signals on the configured time domain resources. When the sensing and communication node is a base station, the base station configures the time domain resources for a terminal to transmit the set of signals. Specifically, the base station may configure the time domain resources for the set of signals received by the base station to the terminal by at least one of: downlink control information, high-layer signaling (e.g., RRC signaling, MAC signaling, etc.). Optionally, the base station may request from the base station via uplink control information to configure the time domain resources for the set of signals transmitted by the terminal. Alternatively, when the sensing and communication node is a terminal, the terminal is configured with the time domain resources for receiving the set of signals. Specifically, the terminal may obtain the time domain resource configurations for the set of signals through at least one of: downlink control information, high-layer signaling (e.g., RRC signaling, MAC signaling, etc.). Optionally, the terminal may request the base station via uplink control information to configure the time domain resources for the set of signals received by the terminal, and/or, the terminal may be configured via downlink control information with the time domain resources for the set of signals received by the terminal.

In a possible implementation of multiple antenna multiplexing, the method shown in FIG. 4 may further include that the sensing and communication node obtains time domain resource configurations, and obtains a plurality of sets of signals based on time domain signals respectively received by a plurality of sub-arrays on the configured time domain resources. For example, the sensing and communication node receives identical time domain signals via an antenna sub-array 1 and an antenna sub-array 2 that are configured with different weights, to obtain a set of signals 1 and a set of signals 2, wherein the number of array elements in the antenna sub-array 1 and the antenna sub-array 2 is less than or equal to the number of RF links of the sensing and communication node. The set of signals 1 and the set of signals 2 may constitute one set of signals, and further, the sensing and communication node constructs an array signal based on the one set of signals. Note that the number of array elements may be the same or different for different antenna sub-arrays.

For example, when receiving a time domain symbol Tᵢ, i=1, . . . , N, the sensing and communication node configures array element weights

$${W}_{i}^{1} , i = 1 , … , N$$

for the antenna sub-array 1, and array element weights

$${W}_{i}^{2} , i = 1 , … , N$$

for the antenna sub-array 2, where

$${W}_{i}^{1} \neq {W}_{i}^{2} , i = 1 , … , N , {W}_{i}^{k} \neq {W}_{j}^{k} , i = 1 , … , N , j = 1 , … , N , i \neq j , k = 1 , 2 ,$$

N is the number of configured time domain symbols. The sensing and communication node receives time domain symbols

$${S}_{i}^{1} , i = 1 , … , N and {S}_{i}^{2} , i = 1 , … , N$$

based on the antenna sub-array 1 and the antenna sub-array 2 that are configured with different weights, respectively, where superscripts 1 and 2 represent the antenna sub-array 1 and the antenna sub-array 2, respectively. After receiving N time domain symbols, the sensing and communication node obtains a set S¹ of signals 1 and a set S² of signals 2, where S¹ and S² are the sets of the N received time domain symbols. Next, the sensing and communication node may form a set based on S¹ and S², e.g., form a set S=[S¹, S²] based on S¹ and S². The sensing and communication node may construct an array signal based on the set S, by at least one of the following ways described above: based on time domain signals, based on frequency domain signals, based on channel estimation results, based on time delay estimation results. It should be noted that the number of antenna sub-arrays is not limited to two, but may be more. The advantage of this implementation is that signal reception is performed with different antenna weights on the same time domain resources by utilizing weight configurations of multiple antennas, and more signals for constructing the array signal may be obtained in the same time, which may effectively reduce the time delay of signal accumulation and achieve faster sensing and/or estimation for received signal, such as DOA estimation.

In one possible implementation of multiple antenna multiplexing, the method shown in FIG. 4 may also include that the sensing and communication node obtains time domain resource configurations and frequency domain resource configurations, and obtains a plurality of sets of signals based on time domain signals respectively received by a plurality of sub-arrays on the same time domain resources. For example, the sensing and communication node receives same time domain symbols through an antenna sub-array 1 and an antenna sub-array 2 configured with different weights, wherein the number of array elements in the antenna sub-arrays 1 and the antenna sub-arrays 2 is less than or equal to the number of RF links of the sensing and communication node. Next, the time domain symbols are Fourier transformed to obtain a set of signals 1 and a set of signals 2 in the frequency domain, respectively, wherein reference signals in the set of signals 1 and the set of signals 2 may be mapped to different subcarriers on the frequency domain resources in a frequency division multiplexing manner. The set of signals 1 in the frequency domain and the set of signals 2 in the frequency domain may constitute one set of signals, and further, the sensing and communication node constructs an array signal based on the obtained one set of signals. Note that the numbers of array elements of different antenna sub-arrays may be the same or different.

Taking OFDM symbols as an example, when receiving a time domain symbol Tᵢ, i=1, . . . , N, the sensing and communication node configures array element weights

$${W}_{i}^{1} , i = 1 , … , N$$

for the antenna sub-array 1, and array element weights

$${W}_{i}^{2} , i = 1 , … , N$$

for the antenna sub-array 2, where

$${W}_{i}^{1} \neq {W}_{i}^{2} , i = 1 , … , N , {W}_{i}^{k} \neq {W}_{j}^{k} , i = 1 , … , N , j = 1 , … , N , i \neq j , k = 1 , 2 ,$$

N is the number of configured time domain symbols. The sensing and communication node receives time domain symbols

$${S}_{i}^{1} , i = 1 , … , N and {S}_{i}^{2} , i = 1 , … , N$$

based on the antenna sub-array 1 and the antenna sub-array 2 that are configured with different weights, respectively, where superscripts 1 and 2 represent the antenna sub-array 1 and the antenna sub-array 2, respectively. After receiving N time domain symbols, the sensing and communication node obtains a set S¹ of signals 1 and a set S² of signals 2 in the time domain, where S¹ and S² are the sets of the N received time domain symbols. Next, the sensing and communication node performs discrete Fourier transform on S¹ and S², based on the frequency domain resource configuration information, such as indexes of subcarriers of the frequency domain resources configured for the antenna sub-array 1 are

$${I}_{i}^{1} , i = 0 , 1 , … , D / 2 - 1 ,$$

and indexes of subcarriers of the frequency domain resources configured for the antenna sub-array 2 are

$${I}_{i}^{2} , i = D / 2 , D / 2 + 1 , … , D - 1 ,$$

where D is the number of array elements in the antenna sub-array 1 and the antenna sub-array 2. It is noted that the numbers of array elements of the antenna sub-array 1 and the antenna sub-array 2 are assumed to be the same in this example. Optionally, the numbers of array elements of different sub-arrays may also be different, and the number of subcarriers of each antenna sub-array configured with a reference signal is related to the number of array elements of the sub-arrays. The sensing and communication nodes obtain a set V¹ of signals 1 and a set V² of signals 2 in the frequency domain based on the indexes

$${I}_{i}^{1} and {I}_{i}^{2}$$

respectively. The sensing and communication node may form a set based on V¹ and V², e.g., form a set V=[V¹, V²] with V¹ and V². The sensing and communication node may construct an array signal based on the set V, by at least one of the following ways described above: based on frequency domain signals, based on channel estimation results, and based on time delay estimation results. It should be noted that the number of antenna sub-arrays is not limited to two, but may be more. The advantage of this implementation is that by utilizing weight configurations of multiple antennas, signal reception is performed on different frequency domain resources on the same time domain resources, which may effectively reduce the time delay of signal accumulation and achieve faster sensing and/or estimation for received signal, such as DOA estimation.

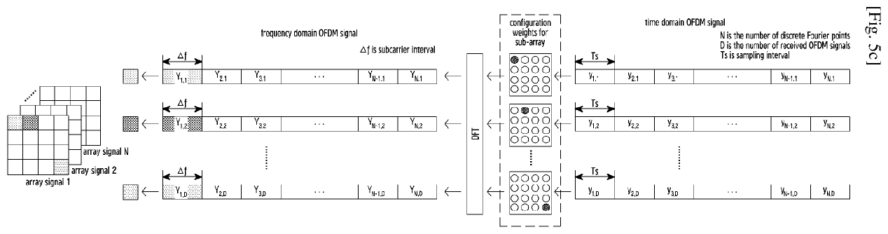

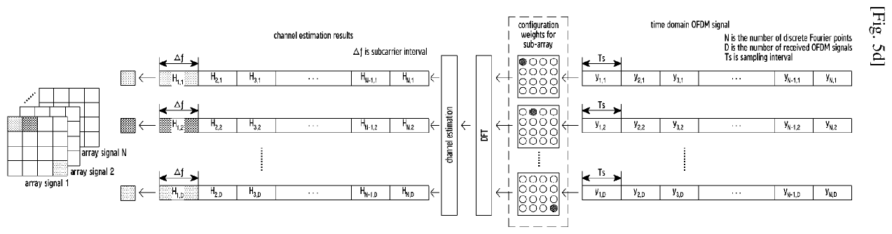

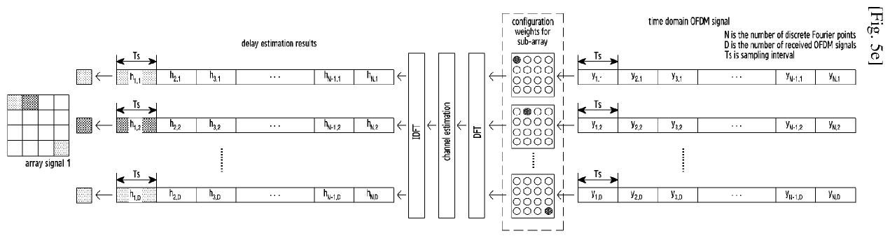

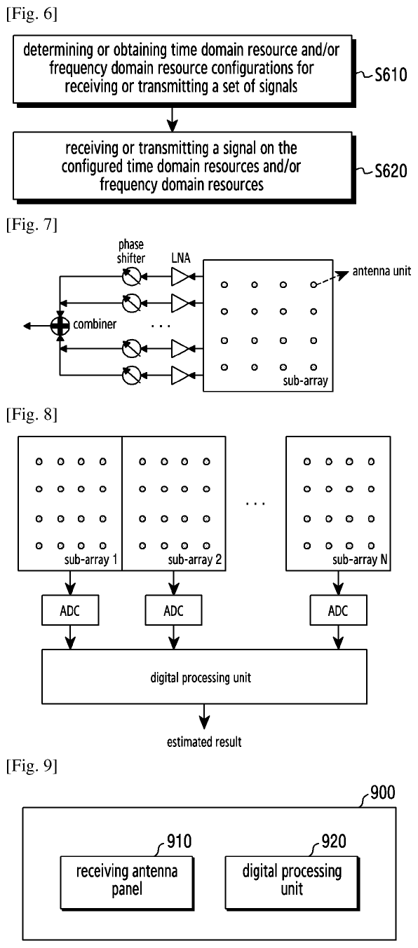

FIG. 6 illustrates a flowchart of a sensing and communication node receiving or transmitting a signal.

In step S610, the sensing and communication node determines or obtains time domain resource and/or frequency domain resource configurations for receiving or transmitting a set of signals, the configurations may be determined by the sensing and communication node itself (e.g., in the case where the sensing and communication node is a base station), or, the configurations may be configured by another node (e.g., in the case where the sensing and communication node is a terminal and the another node is a base station).

In step S620, the sensing and communication node receives or transmits a signal on the configured time domain resources and/or frequency domain resources. Wherein, in the case of self-transmitting and self-receiving, the sensing and communication node transmits a signal on the configured time domain resources and/or frequency domain resources and receives an echo signal of the signal to obtain a set of signals for sensing and/or estimation for received signal, or, in the case of not self-transmitting and self-receiving, the sensing and communication node receives a set of signals on the configured time domain resources and/or frequency domain resources.

In step S610, for the case of self-transmitting and self-receiving, when the sensing and communication node is a base station, the sensing and communication node may determine the time domain resource and/or frequency domain resource configurations for the set of signals by itself, wherein the signal in the set of signals is an echo signal of a downlink signal, and the time domain resource and/or frequency domain resource configurations determined by the sensing and communication node are for the downlink signal. Or, when the sensing and communication node is a terminal, the sensing and communication node may obtain time domain resource and/or frequency domain resource configurations for the set of signals by receiving high-layer signaling, and/or, the sensing and communication node may obtain the time domain resource and/or frequency domain resource configurations for the set of signals by receiving a downlink control channel, wherein the signal in the set of signals is an echo signal of an uplink signal, and the time domain resource and/or frequency domain resource configurations are for the uplink signal.

In step S610, for the case of non-self transmitting and self receiving, when the sensing and communication node is a base station, the sensing and communication node may determine time domain resource and/or frequency domain resource configurations for the set of signals by itself, wherein the signal in the set of signals is an uplink signal and the time domain resource and/or frequency domain resource configurations determined by the sensing and communication node are for the uplink signal. Or, when the sensing and communication node is a terminal, the sensing and communication node may obtain time domain resource and/or frequency domain resource configurations for the set of signals by receiving high-layer signaling, and/or, the sensing and communication node may obtain the time domain resource and/or frequency domain resource configurations for the set of signals by receiving a downlink control channel. Wherein, the signal in the set of signals is a downlink signal and the time domain resource and/or frequency domain resource configurations obtained by the sensing and communication node are configurations for the downlink signal.

Specifically, the contents of the time domain resource and/or frequency domain resource configurations for the set of signals may include at least one of a time domain resource and/or frequency domain resource pattern, a specific time domain resource and/or frequency domain resource pattern index/enabling indication, a period of the time domain resource and/or frequency domain resource pattern, and a duration for which the time domain resource and/or frequency domain resource pattern is valid. Wherein the time domain resource pattern refers to configuration information indicating a location of the time domain resource over a period of time, and the frequency domain resource pattern refers to configuration information indicating a location of the frequency domain resource over a frequency band. Wherein, specifically, the period of time may be one or more time domain symbols and the frequency band may be one or more subcarriers. Wherein the configuration unit of the time domain resource may be a time domain symbol, and the time domain symbol may be an OFDM symbol, but is not limited thereto, and the configuration unit of the frequency domain resource configuration may be a subcarrier, but is not limited thereto. The set of signals may be signals for estimation for received signal and/or sensing, such as for DOA estimation, but is not limited thereto.

According to embodiments, the signal in the set of signals may be a new signal dedicated to perform sensing and/or estimation for received signal. The new signal may be a signal in which a reference signal is mapped to a configured frequency domain resource in a uniform mapping manner. In the uniform mapping manner, an interval between adjacent mapped reference signals is equal, the size of the interval is related to the number of signals in the set of signals and/or the number of reference signals is related to the number of array elements in at least one sub-array used to obtain the set of signals.

For example, the mapping manner of the reference signal in the frequency domain for the new signal may be configurable, and the specific configuration information may be that the reference signal is mapped to configured frequency domain resources in a uniformly mapping manner, wherein the reference signal may be a pseudo-random sequence or a low peak to average power ratio sequence (e.g., a Zedoff-Chu sequence, etc.), but is not limited thereto. For example, the reference signal may be uniformly mapped in such a way that an index of a frequency domain subcarrier to which the reference signal is mapped satisfies k=α+i×N, i=0, . . . , D−1, where α is a starting index of a subcarrier mapped with the reference signal, a subcarrier interval between two adjacent reference signals is N−1, and no reference signal is mapped to N−1 subcarriers between two adjacent reference signals. After the reference signal is performed by frequency domain resource mapping in the above manner, a time domain signal (i.e., the new signal) may be obtained after Fourier inverse transform. The new signal is D time domain symbols of length N, wherein the value of N is related to the sensing performance, the larger the value of N is, the better the sensing performance based on the array signal is, and the value of D is related to the number of signals required, e.g., for a single antenna sub-array, the number of signals required is equal to the number of array elements of the antenna sub-array. It should be noted that when a is an even number, the new signal in the time domain is same D time domain symbol sequences of length N, which may be used to construct the array signal; when a is an odd number, the new signal in the time domain is D time domain symbol sequence of length N, and there is a fixed known phase difference between different time domain symbol sequences, and by compensating the phase difference, same D time domain symbol sequences of length N may be obtained, and then used to construct the array signal.

According to the frequency domain mapping manner of the new signal, the method of obtaining the set of signals by the sensing and communication node may be that the sensing and communication node obtains time domain resource configurations of the new signal, determines lengths and the number of time domain symbols for sensing and a starting position, and the sensing and communication node receives the time domain symbols on the configured time domain resources based on a single sub-array or multiple sub-arrays of the receiving antenna panel to obtain a set of signals. In the case of an OFDM symbol, a frequency domain reference signal R₁, i=1, . . . . D is uniformly mapped on N_{FFT} subcarriers, where N_{FFT} is the number of discrete Fourier transform points, and no resource mapping is performed on the subcarriers between adjacent reference signals. The sensing and communication node configures different weights for array elements of the antenna sub-array to receive a time domain signal of length N (i.e., the new signal), for example, the sensing and communication node configures the antenna array with weights Wᵢ, i=1, . . . , D to receive the number i time domain signal of length N, where i=1, . . . D. Wherein the configuration of the number D of time domain signals is related to the number of signals to be accumulated by the sensing and communication node, e.g., for a single antenna sub-array, the number of signals required is equal to the number of array elements of the antenna sub-array. The configuration of the interval of the subcarriers mapped with the frequency domain reference signal may be based on the requirements of the sensing performance, the higher the value of N is, the better the sensing performance of the sensing and communication node is. Preferably, N is the nth power of 2. The sensing and communication node may construct an array signal based on the obtained set of signals, the method of constructing has been described previously. The advantage of this implementation is that the uniform mapping of the frequency domain reference signal is performed on the frequency domain resources, a plurality of identical time domain signals in the time domain may be obtained after signal processing, and the sensing and communication node may obtain the set of signals that may be used to construct the array signal on fewer time domain resources, thus effectively reducing the time delay of signal accumulation and achieving faster sensing and/or estimation for received signal, such as DOA estimation.

According to an embodiment, in all the above descriptions, the signal may be an uplink signal, a downlink signal, or a new signal as described above, specifically, the uplink signal at least includes one of a demodulation reference signal (DMRS), a sounding reference signal (SRS), a physical signal (SRS), a physical uplink share channel (PUSCH), and a physical uplink control channel (PUCCH), and the downlink signal at least includes one of a demodulation reference signal (DMRS), a channel state information reference signal (CSI-RS), a synchronization signal, a physical downlink share channel (PDSCH), and a physical downlink control channel (PDCCH).

According to an embodiment, after obtaining the set of signals, optionally, the method shown in FIG. 4 may further include performing target detection based on the set of signals. For example, a distance-velocity spectrum may be obtained based on the set of signals and the target detection may be performed based on the distance-velocity spectrum. For example, the distance-velocity spectrum may be obtained by performing Two-Dimensional Discrete Fourier Transform (2D-DFT) on the set of signals. The horizontal and vertical coordinates of the distance-velocity spectrum are distance and velocity, respectively. The higher a measured value (e.g., a received power value) at each point in the distance-velocity spectrum is, the higher the probability that a target is present is, and therefore, the target detection may be performed based on the distance-velocity spectrum.

According to an embodiment, the receiving antenna panel may be divided into a plurality of sub-arrays.

FIG. 7 illustrates a schematic diagram of a structure of a sub-array according to an embodiment of the present disclosure. For example, each sub-array may be linked to a separate RF received link. Wherein each sub-array contains a plurality of antenna units (i.e., antenna array elements or array elements), and each antenna unit is linked with a phase shifter and a low noise amplifier (LNA). By adjusting phase shift of the phase shifter or a mode of the low noise amplifier, the weight of the antenna unit may be adjusted. The received signals received by multiple antenna units on the sub-array are merged into one analog signal through a combiner.

FIG. 8 illustrates a schematic diagram of a sensing and communication node performing angle estimation according to an embodiment of the present disclosure. As shown in FIG. 8, the sensing and communication node may also include a plurality of sub-arrays, a digital processing unit, and an analog digital converter (ADC) corresponding to each of the plurality of sub-arrays. The ADC is used to perform analog digital conversion of a signal received by each sub-array to obtain a digital received signal for each sub-array. For example, received signals received by multiple antenna units on each sub-array are synthesized into an analog received signal by a combiner and sent to the ADC linked to that sub-array, and the analog received signal is converted to a digital received signal, thereby obtaining the digital received signal for each sub-array. Subsequently, the digital processing unit included in the sensing and communication node may receive digital received signals obtained based on individual sub-arrays, and obtain a set of signals, for example, by means of configuring weights for array elements in the sub-arrays described previously.

As mentioned above in the description of FIG. 4, at step S430, sensing and/or estimation for received signal may be performed based on the constructed array signal. The sensing and communication node performing sensing according to the embodiments of the present disclosure has been described above. Since the sensing and communication node is a communication and sensing integrated node, it may perform basic communication functions in addition to the sensing function.

In the following, the sensing and communication node according to the embodiments of the present disclosure performing estimation for received signal is further described in conjunction with examples. The relevant contents mentioned above with respect to steps S410 to S430 in the description of angle estimation are applicable to the estimation for received signal herein, and therefore, they are not repeated.

As described above, according to an embodiment, the receiving antenna panel may be divided into a plurality of sub-arrays, e.g., each of which obtains a corresponding digital received signal via an RF link including a combiner, an ADC. A simple example is to divide the receiving antenna panel into a sub-array 1, . . . , and a sub-array N, for a total of N sub-arrays. Each sub-array generates a digital received signal through the RF link, to obtain a digital received signal 1, . . . , a digital received signal N. After obtaining a set of signals of each sub-array, the set of signals of each subarray may be merged according to a predefined criterion to obtain a merged set of signals.

After obtaining the merged set of signals, the estimation for received signal may be performed based on this set of signals, specifically, for example, channel estimation may be performed on all the signals in the set of signals separately, to obtain a channel estimated set, and all the signals of the channel estimated set may be merged when performing channel equalization to obtain an estimated value of the received signal. Alternatively, channel estimation and equalization may be performed on all the signals in the set of signals separately, and all the signals in the equalized set of signals are merged during signal demodulation to obtain an estimated value of the received signal. Alternatively, channel estimation, channel equalization, and demodulation and decoding may be performed on all the signals in the set of signals separately, and the decoded signals may be merged to obtain an estimated value of the received signal. For example, the merging of all the signals in the set of signals may be performed by performing a maximum ratio merging, and the demodulation may be OFDM demodulation. The estimated value of the received signal may include estimated values of various parameters of the received signal.

The wireless communication method according to the embodiments of the present disclosure has been described above, and according to the above wireless communication method, by receiving signals using the sub-array configured with different weights, it is possible to obtain the required number of signals for sensing and/or estimation for received signal, and by using the obtained signals to construct the array signal, it is possible to achieve more accurate sensing and/or estimation for received signal. In addition, according to the wireless communication method of the embodiments of the present disclosure, by configuring different weights for the sub-array at the time of receiving the signals and receiving the signals using the sub-array configured with different weights, it is possible to perform more accurate sensing and/or estimation for received signal with less resource consumption, and reduce the requirement for the number of RF links.

FIG. 9 illustrates a block diagram of an example of a sensing and communication node according to an embodiment of the present disclosure.

Referring to FIG. 9, the sensing and communication node 900 may include a receiving antenna panel 910 and a digital processing unit 920. The digital processing unit 920 may be configured to obtain a set of signals, construct an array signal based on the set of signals, and perform sensing and/or estimation for received signal based on the constructed array signal. According to the embodiments, the set of signals is obtained based on signals received by a single sub-array or multiple sub-arrays of the receiving antenna panel 910.

Since the method shown in FIG. 4 may be performed by the sensing and communication node 900 shown in FIG. 9, and the digital processing unit 920 may perform steps S410-S430 in FIG. 4, any relevant details involved in the operations performed by the digital processing unit in FIG. 9 may be found in the corresponding descriptions of FIG. 4 and FIGS. 5a through 5e above, none of which will be repeated here. Further, other descriptions of the sensing and communication node prior to FIG. 9 (e.g., example structures of the sensing and communication node, etc.) are also applicable to the sensing and communication node 900 herein and will not be repeated herein.

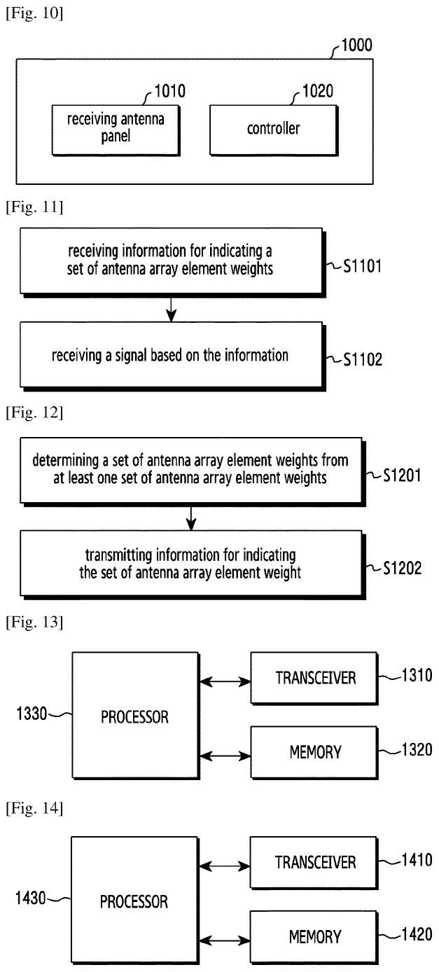

FIG. 10 illustrates a block diagram of another example of a sensing and communication node according to an embodiment of the present disclosure.

Referring to FIG. 10, the sensing and communication node 1000 may include a receiving antenna panel 1010 and at least one controller 1020. At least one controller 1020 may be coupled to the receiving antenna panel 1010 and configured to perform the operations of obtaining a set of signals; constructing an array signal based on the set of signals; and performing sensing and/or estimation for received signal based on the constructed array signal. According to the embodiments, the set of signals is obtained based on signals received by a single sub-array or multiple sub-arrays of the receiving antenna panel 1010.

Again, since the method shown in FIG. 4 may be performed by the sensing and communication node 1000 shown in FIG. 10, and at least one controller 1020 may perform steps S410-S430 in FIG. 4, any relevant details involved in the operations performed by the at least one controller 1020 in FIG. 10 may be found in the corresponding descriptions of FIG. 4 and FIGS. 5a through 5e above, none of which will be repeated here. Further, other descriptions of the sensing and communication node prior to FIG. 10 (e.g., examples of the structure of the sensing and communication node, etc.) are also applicable to the sensing and communication node 1000 herein and will not be repeated herein.

In addition, it should be noted that although the sensing communication node is divided into units for performing corresponding processing separately in the above introduction, it is clear to those skilled in the art that the manner of dividing the units of the sensing and communication node is not limited to the examples of FIG. 9 and FIG. 10, as long as it is capable of performing the methods of the embodiments of the present disclosure.

According to the embodiments, the sensing and communication node 900 and the sensing and communication node 1000 may be a base station side sensing and communication node, a terminal side sensing and communication node, or a sidelink device side sensing and communication node.

FIG. 11 illustrates a flow diagram of a method performed by a user equipment according to an embodiment of the present disclosure.

Referring to FIG. 11, at step S1101, the user equipment may receive information for indicating a set of antenna array element weights, wherein the set of antenna array element weights comprises weights for adjusting antenna array elements.

At step S1102, the user equipment may, based on the information, receive a signal. As an example, the user equipment may, based on the information, determine the set of antenna array element weights from at least one set of antenna array element weights, and receive the signal by using antenna array elements configured based on the weights of the set of antenna array element weights.

Further, the user equipment may receive configuration information associated with the at least one set of antenna array element weights. For example, the configuration information may include weights included in each of the at least one set of antenna array element weights.

In addition, the user equipment may transmit antenna configuration information of the user equipment and/or information about the number of signals required to perform sensing and/or estimation for received signal. Here, the antenna configuration information may include information such as the number of antenna sub-arrays, the number of array elements in the antenna sub-array, etc. For example, the base station may configure time domain resources and/or frequency domain resources for obtaining the set of signals based on the antenna configuration information and/or information about the number of signals required. The user equipment may receive resource configuration information for obtaining the signals.

The signal received by the user equipment may be at least one of an echo signal of an uplink signal and a downlink signal, a new signal, wherein the new signal at least includes a signal in which a reference signal is mapped to a configured frequency domain resource according to an interval. The interval between adjacent mapped reference signals is determined based on the information about the number of the signals. The number of the reference signals is determined based on information about the number of array elements in the antenna configuration information.

According to another embodiment of the present disclosure, a method performed by a user equipment may include receiving resource configuration information; determining a set of antenna array element weights; and obtaining a set of signals for performing sensing and/or estimation for received signal based on the resource configuration information and the set of antenna array element weights.

The step of determining the set of antenna array element weights includes receiving index information for indicating the set of antenna array element weights; and determining the set of antenna array element weights from pre-obtained or generated at least one set of antenna array element weights based on the index information.

The method further includes transmitting antenna configuration information of the user equipment and/or related information of signals required to perform sensing and/or estimation for received signal (such as information on the number of required signals), wherein resources for obtaining the set of signals are configured based on the antenna configuration information and the related information.

The step of obtaining the set of signals for performing sensing and/or estimation for received signal includes transmitting, on configured resources, a signal for performing sensing and/or estimation for received signal; and receiving an echo signal of the signal using at least one sub-array configured based on weights in the set of antenna array element weights to obtain the set of signals.

The method further includes receiving request information; and transmitting, in response to the request information, the antenna configuration information of the user equipment and the related information of the signals required to perform sensing and/or estimation for received signal.

The step of obtaining the set of signals for performing sensing and/or estimation for received signal includes receiving, on configured resources, signals for performing sensing and/or estimation for received signal using at least one sub-array configured based on weights in the set of antenna array elements weights, to obtain the set of signals. Each signal in the set of signals is obtained separately from the at least one sub-array configured with different weights.

The resource configuration information is configuration information for the set of signals, wherein the signal in the set of signals is at least one of an echo signal of an uplink signal, a downlink signal, and a new signal. The new signal at least includes a signal in which a reference signal is mapped to a configured frequency domain resource in a uniform mapping manner. In the uniform mapping manner, an interval between adjacent reference signals is related to the number of signals in the set of signals, and/or the number of the reference signals is related to the number of array elements in the at least one sub-array.

FIG. 12 illustrates a flow diagram of a method performed by a base station according to an embodiment of the present disclosure.

Referring to FIG. 12, at step S1201, the base station may determine a set of antenna array element weights from at least one set of antenna array element weights, wherein the set of antenna array element weights includes weights for adjusting antenna array elements.

At step S1202, information for indicating the set of antenna array element weights is transmitted.

The base station may send configuration information associated with the at least one set of antenna array element weights.

The base station may receive antenna configuration information of the user equipment and/or information about the number of signals required to perform sensing and/or estimation for received signal, and transmit resource configuration information used to obtain the signals.

When the base station receives a signal, the signal may be an echo signal of a downlink signal, an uplink signal or a new signal.

According to another embodiment of the present disclosure, a method performed by a base station may include determining resource configurations and a set of antenna array element weights; and obtaining a set of signals for performing sensing and/or estimation for received signal based on the resource configurations and the set of antenna array element weights.

The step of determining the resource configurations includes determining the resource configurations based on antenna configuration information of the base station and related information of signals required to perform sensing and/or estimation for received signal.

The step of determining the set of antenna array element weights includes receiving index information for indicating the set of antenna array element weights; and determining the set of antenna array element weights from pre-obtained or generated at least one set of antenna array element weights based on the index information.

The step of obtaining the set of signals for performing sensing and/or estimation for received signal includes transmitting, on configured resources, a signal for performing sensing and/or estimation for received signal; and receiving an echo signal of the signal using at least one sub-array configured based on weights in the set of antenna array element weights to obtain the set of signals.

The step of obtaining the set of signals for performing sensing and/or estimation for received signal includes transmitting information related to the resource configurations; and receiving, at the configured resources, signals for performing sensing and/or estimation for received signal using at least one sub-array configured based on weights in the set of antenna array elements weights to obtain the set of signals.

The method further includes transmitting a request message; receiving, based on the request message, antenna configuration information of another node and related information of signals required to perform sensing and/or estimation for received signal; configuring, based on the antenna configuration information of the another node and the related information, resources for the another node to obtain a set of signals for performing sensing and/or estimation for received signal; and transmitting configuration information of the resources. Each signal in the set of signals is obtained separately by the at least one sub-array configured with different weights.

The resource configurations are configurations for the set of signals, wherein the signal in the set of signals is at least one of an echo signal of a downlink signal, an uplink signal, and a new signal. The new signal at least includes a signal in which a reference signal is mapped to a configured frequency domain resource in a uniform mapping manner. In the uniform mapping manner, an interval between adjacent reference signals is related to the number of signals in the set of signals, and/or the number of the reference signals is related to the number of array elements in the at least one sub-array.

FIG. 13 illustrates a block diagram of a terminal (or a user equipment (UE)), according to embodiments of the present disclosure. FIG. 13 corresponds to the example of the UE of FIG. 3a.

As shown in FIG. 13, the UE according to an embodiment may include a transceiver 1310, a memory 1320, and a processor 1330. The transceiver 1310, the memory 1320, and the processor 1330 of the UE may operate according to a communication method of the UE described above. However, the components of the UE are not limited thereto. For example, the UE may include more or fewer components than those described above. In addition, the processor 1330, the transceiver 1310, and the memory 1320 may be implemented as a single chip. Also, the processor 1330 may include at least one processor.

The transceiver 1310 collectively refers to a UE receiver and a UE transmitter, and may transmit/receive a signal to/from a base station or a network entity. The signal transmitted or received to or from the base station or a network entity may include control information and data. The transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

Also, the transceiver 1310 may receive and output, to the processor 1330, a signal through a wireless channel, and transmit a signal output from the processor 1330 through the wireless channel.

The memory 1320 may store a program and data required for operations of the UE. Also, the memory 1320 may store control information or data included in a signal obtained by the UE. The memory 1320 may be a storage medium, such as read-only memory (ROM), random access memory (RAM), a hard disk, a CD-ROM, and a DVD, or a combination of storage media.

The processor 1330 may control a series of processes such that the UE operates as described above. For example, the transceiver 1310 may receive a data signal including a control signal transmitted by the base station or the network entity, and the processor 1330 may determine a result of receiving the control signal and the data signal transmitted by the base station or the network entity.

FIG. 14 illustrates a block diagram of a base station, according to embodiments of the present disclosure. FIG. 14 corresponds to the example of the gNB of FIG. 3b.

As shown in FIG. 14, the base station according to an embodiment may include a transceiver 1410, a memory 1420, and a processor 1430. The transceiver 1410, the memory 1420, and the processor 1430 of the base station may operate according to a communication method of the base station described above. However, the components of the base station are not limited thereto. For example, the base station may include more or fewer components than those described above. In addition, the processor 1430, the transceiver 1410, and the memory 1420 may be implemented as a single chip. Also, the processor 1430 may include at least one processor.

The transceiver 1410 collectively refers to a base station receiver and a base station transmitter, and may transmit/receive a signal to/from a terminal or a network entity. The signal transmitted or received to or from the terminal or a network entity may include control information and data. The transceiver 1410 may include a RF transmitter for up-converting and amplifying a frequency of a transmitted signal, and a RF receiver for amplifying low-noise and down-converting a frequency of a received signal. However, this is only an example of the transceiver 1410 and components of the transceiver 1410 are not limited to the RF transmitter and the RF receiver.

Also, the transceiver 1410 may receive and output, to the processor 1430, a signal through a wireless channel, and transmit a signal output from the processor 1430 through the wireless channel.

The memory 1420 may store a program and data required for operations of the base station. Also, the memory 1420 may store control information or data included in a signal obtained by the base station. The memory 1420 may be a storage medium, such as read-only memory (ROM), random access memory (RAM), a hard disk, a CD-ROM, and a DVD, or a combination of storage media.

The processor 1430 may control a series of processes such that the base station operates as described above. For example, the transceiver 1410 may receive a data signal including a control signal transmitted by the terminal, and the processor 1430 may determine a result of receiving the control signal and the data signal transmitted by the terminal.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

According to an embodiment of the present disclosure, an electronic device is further provided, the device including at least one processor; and at least one memory storing computer-executable instructions, wherein the computer-executable instructions, when run by the at least one processor, cause the at least one processor to perform any one of the methods as described above.

As an example, the electronic device may be a PC computer, a tablet device, a personal digital assistant, a smartphone, or any other device capable of executing the above instruction set. Here, the electronic device does not have to be a single electronic device, but may also be any set of devices or circuits capable of executing the above instructions (or instruction set) individually or jointly. The electronic device may also be a part of an integrated control system or system manager, or may be configured as a portable electronic device that interfaces locally or remotely (e.g., via wireless transmission).

In the electronic device, the processor may include a central processing unit (CPU), graphics processing unit (GPU), programmable logic device, special purpose processor system, microcontroller or microprocessor. By way of example and not limitation, the processor may also include analog processors, digital processors, microprocessors, multi-core processors, processor arrays, network processors, and the like.

The processor may execute instructions or code stored in the memory, which may also store data. Instructions and data may also be sent and received over a network via a network interface, which may employ any known transport protocol.

The memory may be integrated with the processor, e.g., a RAM or flash memory is arranged within an integrated circuit microprocessor or the like. Additionally, the memory may include a separate device such as an external disk drive, storage array, or any other storage device that may be used by a database system. The memory and the processor may be operatively coupled, or may communicate with each other, e.g., through I/O ports, network connections, etc., to enable the processor to read files stored in the memory.

In addition, the electronic device may also include video displays (e.g. liquid crystal display) and user interaction interfaces (e.g. keyboard, mouse, touch input device, etc.). All components of the electronic device may be connected to each other via a bus and/or a network.

According to an embodiment of the present disclosure, a computer readable storage medium storing instructions is also provided. The instructions, when executed by at least one processor, causes the at least one processor to perform any of the above methods according to the exemplary embodiments of the present disclosure. Examples of computer-readable storage media herein include: Read Only Memory (ROM), Random Access Programmable Read Only Memory (RAPROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BDROM, BD-R, BD-R LTH, BD-RE, Blue-ray or optical disk storage, Hard Disk Drive (HDD), Solid State Drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs. The instructions or computer programs in the computer-readable storage medium described above may be executed in an environment deployed in a computer device, such as client, host, proxy device, server, etc. In addition, in one example, the computer programs and any associated data, data files, and data structures are distributed on a networked computer system, so that the computer programs and any associated data, data files, and data structures are stored, accessed and executed through one or more processors or computers in a distributed manner.

It should be noted that the terms “first”, “second”, “third”, “fourth”, “1”, “2”, etc. (if present) used in the specification and claims and the accompanying drawings above of the present disclosure are used to distinguish similar objects and are not necessary for describing a particular order or sequence. It should be understood that the data so used is interchangeable in appropriate cases so that the embodiments of the present disclosure described herein may be implemented in an order other than that illustrated or described herein.

It should be understood that while the flowcharts of the embodiments of the present disclosure indicate the individual operational steps by arrows, the order of these implementation steps is not limited to the order indicated by the arrows. Unless explicitly stated herein, in some implementation scenarios of the embodiments of the present disclosure, the implementation steps in the respective flowcharts may be performed in other orders as desired. In addition, some or all of the steps in each flowchart may include multiple sub-steps or multiple stages based on actual implementation scenarios. Some or all of these sub-steps or stages may be executed at the same moment, and each of these sub-steps or stages may also be executed separately at different moments. In the scenarios where the execution moments are different, the order of execution of these sub-steps or stages may be flexibly configured according to the needs, and the embodiments of the present disclosure are not limited thereto.

The above description is only an optional implementation of part of the implementation scenarios of the present disclosure. It should be noted that for those ordinary skill in the art, other similar means of implementation based on the technical idea of the present disclosure, without departing from the technical idea of the present disclosure, also fall within the scope of protection of the embodiments of the present disclosure.

Other embodiments of the present disclosure will readily be conceived by those skill in the art after considering the specification and practicing the invention disclosed herein. The present disclosure is intended to cover any variation, use, or adaptation of the present disclosure that follows the general principle of the present disclosure and includes commonly known or customary technical means in the art not disclosed herein. The specification and embodiments are to be considered exemplary only, and the true scope and spirit of the disclosure is limited by the claims.

1. A method performed by a user equipment in a wireless communication system, the method comprising:
receiving information for indicating a set of antenna array element weights, wherein the set of antenna array element weights includes weights for adjusting antenna array elements; and
receiving a signal based on the information.

2. The method of claim 1, wherein the receiving of the signal based on the information comprises:
determining, based on the information, the set of antenna array element weights from at least one set of antenna array element weights;
receiving the signal by using antenna array elements configured based on the weights of the set of antenna array element weights; and
receiving configuration information associated with the at least one set of antenna array element weights.

3. The method of claim 1, wherein the method further comprises:
transmitting antenna configuration information of the user equipment and/or information about the number of signals required to perform sensing and/or estimation for received signal; and
receiving resource configuration information used to obtain the signals.

4. The method of claim 3, wherein the signal is at least one of an echo signal of an uplink signal, a downlink signal, and a new signal,
wherein the new signal at least comprises a signal in which a reference signal is mapped to a configured frequency domain resource according to an interval,
wherein the interval between adjacent mapped reference signals is determined based on the information about the number of the signals,
wherein the number of the reference signals is determined based on information about the number of array elements in the antenna configuration information.

5. A method performed by a base station in a wireless communication system, the method comprising:
determining a set of antenna array element weights from at least one set of antenna array element weights, wherein the set of antenna array element weights includes weights for adjusting antenna array elements; and
transmitting information for indicating the set of antenna array element weights.

6. The method of claim 5, wherein the method further comprises:
receiving antenna configuration information of the user equipment and/or information about the number of signals required to perform sensing and/or estimation for received signal; and
transmitting resource configuration information used to obtain the signals.

7. The method of claim 6, wherein the signal is at least one of an echo signal of an uplink signal, a downlink signal, and a new signal,
wherein the new signal at least comprises a signal in which a reference signal is mapped to a configured frequency domain resource according to an interval,
wherein the interval between adjacent mapped reference signals is determined based on the information about the number of the signals,
wherein the number of the reference signals is determined based on information about the number of array elements in the antenna configuration information.

8. A method performed by a node in a wireless communication system, the method comprising:
obtaining a set of signals;
constructing an array signal based on the set of signals; and
performing sensing and/or estimation for received signal based on the array signal,
wherein each signal in the set of signals is obtained by at least one sub-array configured with weights, respectively.

9. The method of claim 8, wherein the method further comprises:
obtaining a set of antenna array element weights with respect to each signal;
selecting, from the set of antenna array element weights, a weight vector for the at least one sub-array; and
adjusting, based on the weight vector, the weights corresponding to each array element in the at least one sub-array.

10. The method of claim 9,
wherein the adjustment to the weights comprises adjusting at least one of a phase and an amplitude of the array element,
wherein the set of antenna array element weights comprises a plurality of weight vectors,
wherein the selecting, from the set of antenna array element weights, the weight vector for the at least one sub-array comprises:
calculating a correlation coefficient between every two weight vectors included in the set of antenna array element weights; and
selecting the weight vector based on the correlation coefficient.

11. The method of claim 10, wherein the selecting of the weight vector based on the correlation coefficient comprises:
selecting, from the set of antenna array element weights, a weight vector having the lowest correlation coefficient with a weight vector used to receive a previous signal, as the weight vector used to receive the current signal.

12. The method of claim 8, wherein the signal in the set of signals is at least one of an echo signal of a downlink signal, an uplink signal, and a new signal,
wherein the downlink signal at least comprises one of a demodulation reference signal, a channel state information reference signal, a synchronization signal, a physical downlink shared channel, and a physical downlink control channel,
wherein the uplink signal at least comprises one of a demodulation reference signal, a sounding reference signal, a physical uplink shared channel, and a physical uplink control channel, and
wherein the new signal at least comprises a signal in which a reference signal is mapped to a configured frequency domain resource at an interval.

13. The method of claim 8, wherein the signal in the set of signals is at least one of an echo signal of an uplink signal, a downlink signal, and a new signal,
wherein the downlink signal at least comprises one of a demodulation reference signal, a channel state information reference signal, a synchronization signal, a physical downlink shared channel, and a physical downlink control channel,
the uplink signal at least comprises one of a demodulation reference signal, a sounding reference signal, a physical uplink shared channel, and a physical uplink control channel, and
the new signal at least comprises a signal in which a reference signal is mapped to a configured frequency domain resource at an interval.

14. A base station in a wireless communication system, the base station comprising
a transceiver;
memory, comprising one or more storage media, storing instructions; and
one or more processors communicatively coupled to the transceiver and the memory,
wherein the instructions, when executed by the one or more processors individually or collectively, cause the base station to;
determine a set of antenna array element weights from at least one set of antenna array element weights, wherein the set of antenna array element weights includes weights for adjusting antenna array elements; and
transmit information for indicating the set of antenna array element weights.

15. A user equipment in a wireless communication system, the user equipment comprising:
a transceiver;
memory, comprising one or more storage media, storing instructions; and
one or more processors communicatively coupled to the transceiver and the memory,
wherein the instructions, when executed by the one or more processors individually or collectively, cause the user equipment to:
receive information for indicating a set of antenna array element weights, wherein the set of antenna array element weights includes weights for adjusting antenna array elements; and
receive a signal based on the information.

16. The base station of claim 14, wherein the instructions, when executed by the one or more processors individually or collectively, further cause the base station to:
receive antenna configuration information of the user equipment and/or information about the number of signals required to perform sensing and/or estimation for received signal; and
transmit resource configuration information used to obtain the signals.

17. The base station of claim 16, wherein the signal is at least one of an echo signal of an uplink signal, a downlink signal, and a new signal,
wherein the new signal at least comprises a signal in which a reference signal is mapped to a configured frequency domain resource according to an interval,
wherein the interval between adjacent mapped reference signals is determined based on the information about the number of the signals,
wherein the number of the reference signals is determined based on information about the number of array elements in the antenna configuration information.

18. The user equipment of claim 15, wherein, to receive the signal based on the information, the instructions, when executed by the one or more processors individually or collectively, further cause the user equipment to:
determine, based on the information, the set of antenna array element weights from at least one set of antenna array element weights;
receive the signal by using antenna array elements configured based on the weights of the set of antenna array element weights; and
receive configuration information associated with the at least one set of antenna array element weights.

19. The user equipment of claim 15, wherein the instructions, when executed by the one or more processors individually or collectively, further cause the user equipment to:
transmit antenna configuration information of the user equipment and/or information about the number of signals required to perform sensing and/or estimation for received signal; and
receive resource configuration information used to obtain the signals.

20. The user equipment of claim 19, wherein the signal is at least one of an echo signal of an uplink signal, a downlink signal, and a new signal,
wherein the new signal at least comprises a signal in which a reference signal is mapped to a configured frequency domain resource according to an interval,
wherein the interval between adjacent mapped reference signals is determined based on the information about the number of the signals,
wherein the number of the reference signals is determined based on information about the number of array elements in the antenna configuration information.
